(19) United States
(12) Patent Application Publication
(10) Pub. No.: US 2024/0419147 A1
(43) Pub. Date: Dec. 19, 2024

(54) PLANT DRAWING LINE DETECTION SYSTEM, PLANT DRAWING LINE DETECTION METHOD, AND COMPUTER-READABLE RECORDING MEDIUM

(71) Applicant: Yokogawa Electric Corporation, Tokyo (JP)

(72) Inventors: Takaaki MATSUDA, Tokyo (JP); Takahiro KAMBE, Tokyo (JP); Shin OKUYAMA, Tokyo (JP); Satoshi ASAWA, Tokyo (JP)

(21) Appl. No.: 18/739,993

(22) Filed: Jun. 11, 2024

(30) Foreign Application Priority Data
Jun. 19, 2023 (JP) 2023-100331

(51) Int. Cl. G05B 19/4097

(52) U.S. Cl. CPC G05B 19/4097; G05B 2219/35292; G05B 2219/35489; G05B 2219/36317; G05B 2219/37371

(57) ABSTRACT

A plant drawing line detection system acquires a plant drawing that is used for construction, operation, and maintenance of a plant, displays the acquired plant drawing, accepts selection of a line that is desired from among a plurality of lines that are present in the displayed plant drawing, registers a line pattern of the accepted selection of the line, detects, from the displayed plant drawing, all of the lines each having a shape that is matched with a shape of the registered line pattern including the line that has been used for the selection, and provides a detection result related to the lines.

### CROSS-REFERENCE TO RELATED APPLICATION

The present application claims priority to and incorporates by reference the entire contents of Japanese Patent Application No. 2023-100331 filed in Japan on Jun. 19, 2023.

### FIELD

The present invention relates a plant drawing line detection system, a plant drawing line detection method, and a computer-readable recording medium.

### BACKGROUND

There is a known technology for structuring a raster format drawing, such as a building diagram, a layout drawing, a piping and instrumentation diagram (P&ID), an elementary control wiring diagram (ECWD), an interlock block diagram (IBD), a single line connection diagram, and a soft logic diagram, of a plant by converting the raster format drawing to a vector format drawing. Furthermore, there is a known technology for improving accuracy of recognition of symbols that indicate measuring instruments or the like depicted in the drawing related to the plant.

However, with the above described technology, it is difficult to efficiently provide information related to the lines from the drawing that is used for construction, operation, and maintenance of the plant (hereinafter, appropriately referred to as a “plant drawing”). For example, with the above described technology, it is difficult to provide the lines by registering a pattern of a line that is desired by a user from among a plurality of lines included in the plant drawing and detecting all of the lines having the shape that is matched with the shape of the registered pattern from among the plant drawing.

### SUMMARY

According to an aspect of the embodiments, a plant drawing line detection system includes a control unit that is configured to acquire a drawing that is used for construction, operation, and maintenance of a plant, display the acquired drawing, accept selection of a line that is desired from among a plurality of lines that are present in the displayed drawing, register a pattern of the accepted selection of the line, detect, from the displayed drawing, all of the lines each having a shape that is matched with a shape of the registered pattern of the line including the line that has been used for the selection, and provide a detection result related to the lines.

According to an aspect of the embodiments, a plant drawing line detection method that causes a computer to execute a process includes acquiring a drawing that is used for construction, operation, and maintenance of a plant, displaying the acquired drawing, accepting selection of a line that is desired from among a plurality of lines that are present in the displayed drawing, registering a pattern of the accepted selection of the line, detecting, from the displayed drawing, all of the lines each having a shape that is matched with a shape of the registered pattern of the line including the line that has been used for the selection, and providing a detection result related to the lines.

According to an aspect of the embodiments, a computer-readable recording medium having stored therein a plant drawing line detection program that causes a computer to execute a process includes acquiring a drawing that is used for construction, operation, and maintenance of a plant, displaying the acquired drawing, accepting selection of a line that is desired from among a plurality of lines that are present in the displayed drawing, registering a pattern of the accepted selection of the line, detecting, from the displayed drawing, all of the lines each having a shape that is matched with a shape of the registered pattern of the line including the line that has been used for the selection; and providing a detection result related to the lines.

### BRIEF DESCRIPTION OF THE DRAWINGS

FIG. 1 is a diagram illustrating a configuration example and a process example of an information providing system according to a first embodiment;

FIG. 2 is a block diagram illustrating a configuration example of each of devices included in the information providing system according to the first embodiment;

FIG. 3 is a diagram illustrating one example of a plant drawing information storage unit included in a server device according to the first embodiment;

FIG. 4 is a diagram illustrating one example of a symbol pattern information storage unit included in the server device according to the first embodiment;

FIG. 5 is a diagram illustrating one example of a symbol detection information storage unit included in the server device according to the first embodiment;

FIG. 6 is a diagram illustrating one example of a detection model storage unit included in the server device according to the first embodiment;

FIG. 7 is a diagram illustrating a specific example 1 of a display screen displayed on a plant administrator terminal according to the first embodiment;

FIG. 8 is a diagram illustrating a specific example 2 of a display screen displayed on the plant administrator terminal according to the first embodiment;

FIG. 9 is a diagram illustrating a specific example 3 of a display screen displayed on the plant administrator terminal according to the first embodiment;

FIG. 10 is a sequence diagram illustrating one example of the flow of the process performed in the entire information providing system according to the first embodiment;

FIG. 11 is a diagram illustrating a configuration example and a process example of an information providing system according to a second embodiment;

FIG. 12 is a block diagram illustrating a configuration example of each of devices included in the information providing system according to the second embodiment;

FIG. 13 is a diagram illustrating one example of a line pattern information storage unit included in a server device according to the second embodiment;

FIG. 14 is a diagram illustrating one example of a line detection information storage unit included in the server device according to the second embodiment;

FIG. 15 is a diagram illustrating a specific example 1 of a display screen displayed on a plant administrator terminal according to the second embodiment;

FIG. 16 is a diagram illustrating a specific example 2 of a display screen displayed on the plant administrator terminal according to the second embodiment;

FIG. 17 is a diagram illustrating a specific example 3 of a display screen displayed on the plant administrator terminal according to the second embodiment;

FIG. 18 is a sequence diagram illustrating one example of the flow of the process performed in the entire information providing system according to the second embodiment;

FIG. 19 is a diagram illustrating a configuration example and a process example of an information providing system according to a third embodiment;

FIG. 20 is a block diagram illustrating a configuration example of each of devices included in the information providing system according to the third embodiment;

FIG. 21 is a diagram illustrating one example of a flow direction detection information storage unit included in a server device according to the third embodiment;

FIG. 22 is a diagram illustrating a specific example 1 of a display screen displayed on a plant administrator terminal according to the third embodiment;

FIG. 23 is a diagram illustrating a specific example 2 of a display screen displayed on the plant administrator terminal according to the third embodiment;

FIG. 24 is a diagram illustrating a specific example 3 of a display screen displayed on the plant administrator terminal according to the third embodiment;

FIG. 25 is a sequence diagram illustrating one example of the flow of the process performed in the entire information providing system according to the third embodiment; and

FIG. 26 is a diagram illustrating an example of a hardware configuration according to each of the first to the third embodiments.

### DESCRIPTION OF EMBODIMENTS

Preferred embodiments of an information providing system (a plant drawing symbol detection system or a plant drawing line detection system), an information providing method (plant drawing symbol detection method or a plant drawing line detection method), and a computer-readable recording medium having stored therein an information providing program (a plant drawing symbol detection program or a plant drawing line detection program) according to a first to a third embodiments of the present invention will be explained in detail below with reference to the accompanying drawings. Furthermore, the present invention is not limited to the embodiments described below.

### First Embodiment

In the following, a configuration and a process related to an information providing system 100-1 that is a plant drawing symbol detection system according to a first embodiment, a configuration and a process related to each of devices that are included in the information providing system 100-1, and the flow of the process performed in the information providing system 100-1 will be described in this order and, at the end, effects of the embodiment will be described.

### 1. Configuration and Process Related to Information Providing System 100-1

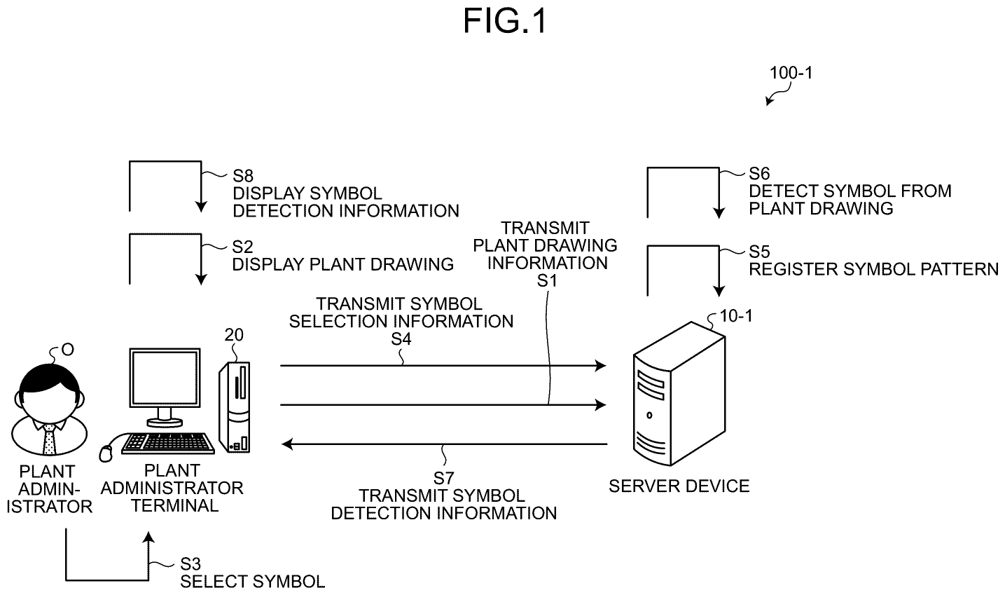

A configuration and a process related to the information providing system 100-1 according to the first embodiment will be described with reference to FIG. 1. FIG. 1 is a diagram illustrating the configuration example and the process example of the information providing system 100-1 according to the first embodiment. In a description below, the configuration example of the entire information providing system 100-1, the process example of the information providing system 100-1, and the effects of the information providing system 100-1 will be described.

### 1-1. Configuration Example of Entire Information Providing System 100-1

A configuration example of the entire information providing system 100-1 according to the first embodiment will be described. The information providing system 100-1 includes a server device 10-1 that is an information providing device (plant drawing symbol detection device), and a plant administrator terminal 20 that is used by a plant administrator O. Here, the server device 10-1 and the plant administrator terminal 20 are connected via a predetermined communication network (network) (not illustrated) so as to be able to communicate each other in a wired or wireless manner. Furthermore, for the predetermined communication network, it is possible to use various communication networks including the Internet, a dedicated line, or the like. Moreover, in the information providing system 100-1 illustrated in FIG. 1, two or more of the server devices 10-1 or two or more of the plant administrator terminals 20 may be included.

### 1-2. Process Example of Entire Information Providing System 100-1

A process example of the entire information providing system 100-1 according to the first embodiment will be described. Furthermore, the processes performed at Steps S1 to S7 may also be in different order. Moreover, from among the processes performed at Steps S1 to S7 described below, there may be a process that is omitted.

### 1-2-1. Plant Drawing Information Transmission Process

At a first step, the plant administrator terminal 20 transmits plant drawing information to the server device 10-1 (Step S1). For example, the plant administrator terminal 20 transmits the plant drawing information that has been selected by an operation performed by the plant administrator O to the server device 10-1. At this time, the server device 10-1 receives the plant drawing information and stores the received plant drawing information.

Here, the plant drawing indicates a drawing that is used for construction, operation, and maintenance of a plant, and is, for example, a building diagram, a layout drawing, a P&ID, an ECWD, an IBD, a single line connection diagram, a soft logic diagram, or the like of the plant generated by digital data.

### 1-2-2. Plant Drawing Displaying Process

At a second step, the plant administrator terminal 20 displays the plant drawing (Step S2). For example, the plant administrator terminal 20 displays the plant drawing that has been selected by the operation performed by the plant administrator O on a monitor screen.

### 1-2-3. Symbol Selection Process

At a third step, the plant administrator O selects a symbol by operating the plant administrator terminal 20 (Step S3). For example, the plant administrator O selects the symbol associated with a control instrument by performing a click operation on the symbol associated with the control instrument included in the plant drawing that is displayed on a monitor screen of the plant administrator terminal 20.

Here, the symbol indicates a sign that indicates a component of the plant and that is illustrated in the plant drawing. Furthermore, the component of the plant mentioned here indicates a plant instrument (e.g.: a control instrument, a communication instrument, or a measurement instrument) that constitutes the plant, a plant facility (e.g.: a tank or a furnace), or the like.

### 1-2-4. Symbol Selection Information Transmission Process

At a fourth step, the plant administrator terminal 20 transmits symbol selection information to the server device 10-1 (Step S4). For example, the plant administrator terminal 20 transmits identification information on the symbol associated with the control instrument selected by the plant administrator O or positional information on the position of the symbol illustrated in the plant drawing to the server device 10-1.

### 1-2-5. Symbol Pattern Registration Process

At a fifth step, the server device 10-1 registers a symbol pattern (Step S5). For example, the server device 10-1 acquires the plant drawing information on the basis of the symbol selection information received from the plant administrator terminal 20, and specifies the symbol pattern from the digital data on the symbol associated with the corresponding control instrument. At this time, the server device 10-1 stores the specified symbol pattern as symbol pattern information.

Here, the symbol pattern indicates the identification information for identifying the shape of a symbol, and is, for example, a diagram, a line type, a color, or the like of the symbol.

### 1-2-6. Symbol Detection Process

At a sixth step, the server device 10-1 detects the symbol from the plant drawing (Step S6). For example, the server device 10-1 searches the acquired plant drawing information, and detects the symbol having the symbol pattern that is matched with or similar to the specified symbol pattern. At this time, the server device 10-1 generates symbol detection information that includes a symbol detection drawing that is a highlighted plant drawing obtained by coloring the detected symbol, and stores the generated symbol detection information. Furthermore, the server device 10-1 generates the symbol detection information that includes a symbol detection list that indicates a list of detected symbols, and stores the generated symbol detection information.

The server device 10-1 may detect the symbol by using a detection model DM that is a machine learning model, and, in the case where a detection mistake, such as a detection omission or erroneous detection, has been made in the symbol detection information, the server device 10-1 may notify the plant administrator O of the detection mistake.

### 1-2-7. Symbol Detection Information Transmission Process

At a seventh step, the server device 10-1 transmits the symbol detection information to the plant administrator terminal 20 (Step S7). For example, the server device 10-1 transmits the symbol detection information that includes the symbol detection drawing and the symbol detection list to the plant administrator terminal 20.

### 1-2-8. Symbol Detection Information Displaying Process

At an eighth step, the plant administrator terminal 20 displays the symbol detection information (Step S8). For example, the plant administrator terminal 20 displays the symbol detection drawing that is included in the received symbol detection information on the monitor screen. Furthermore, the plant administrator terminal 20 may also display the symbol detection list that is included in the received symbol detection information on the monitor screen.

### 1-3. Overall Effect of Information Providing System 100-1

In the following, a background of the plant drawing, an outline associated with and the point at issue in the reference technology will be described, and then, the effect of the information providing system 100-1 will be described.

### 1-3-1. Background of Plant Drawing

In recent years, a technology related to a plant has been drawing attention. For example, the software market of international plant engineering has expanded every year, and further expansion is expected. For construction, operation, and maintenance of the plant, a plant drawing, such as a building diagram, a layout drawing, a P&ID, or an IBD, of the plant is used.

Here, historical circumstances of a plant drawing will be described by using a P&ID that is a plant drawing as an example. First, in an introduction period or in a spread period of the plant drawing, a paper P&ID is used; then, a P&ID generated by a two-dimensional Computer-Aided Design (CAD) generated by digital data is used; subsequently, an intelligent P&ID in which tag information or the like related to a plant instrument is added is used; and in the future, next generation of intelligent P&ID that is a further efficient plant drawing is presumed to be used. In recent years, a technique for the P&ID is being transitioned from the paper P&ID or the P&ID generated by a two-dimensional CAD to the intelligent P&ID.

In a process of construction, operation, and maintenance of the plant, there is a need to generate a list of the instruments and materials illustrated in the plant drawing, such as a building diagram, a layout drawing, a P&ID, an IBD, or the like, of the plant. However, for example, in the case where the plant drawing is a P&ID generated by a two-dimensional CAD, there is a need for an engineer to visually detect a symbol associated with an instrument or a material from the plant drawing, which is inefficient, and a human error tends to occur.

Accordingly, there is a demand for a technology for registering a pattern of a desired symbol from among a plurality of symbols that are present in the plant drawing that is used for construction, operation, and maintenance of the plant, detecting all of the symbols each having a shape or the like that is matched with the shape or the like of the registered pattern from the plant drawing, and providing the detected symbol.

### 1-3-2. Outline of Reference Technology

Here, the outline associated with the reference technology related to the plant drawing will be described. In the following, a reference technology 1 that allows for automatic structuring of a raster format drawing, and a reference technology 2 that is a technology for structuring a drawing capable of improving recognition accuracy of the symbols depicted in a drawing will be described.

The reference technology 1 structures structural elements by converting, as vector conversion, a raster format drawing to a vector format drawing, holding a structured rule definition database in which a rule that is used at the time of structuring of the structural elements that are included in the vector format drawing, and adding, by referring to the structured rule definition database, attribute information and connection information to the structural elements that are included in the vector format drawing.

The reference technology 2 structures a vector format drawing by holding a structured rule definition database that stores therein a rule for defining attribute information that indicates an attribute of each of the symbols and a connection relation between each of the symbols and respective line segments, recognizing the symbols that are depicted in the raster format drawing, converting the raster format drawing to the vector format drawing, arranging the symbol that has been specified on the basis of the recognition result of the symbols in the vector format drawing, and adding the attribute information to each of the symbols by using the attribute information and the rule that are stored in the structured rule definition database.

### 1-3-3. Point at Issue of Reference Technology

However, in the technologies of the reference technology 1 and the reference technology 2, there is a problem in that it is difficult to register the pattern of the desired symbol from among the plurality of symbols that are present in the plant drawing that is used for construction, operation, and maintenance of the plant, detect all of the symbols each having a shape or the like that is matched with the shape or the like of the registered pattern from the plant drawing, and provide the detected symbols. Furthermore, there is also a known detection technology for detecting a symbol from a plant drawing, such as a P&ID, generated by the two-dimensional CAD by using a machine learning model, but there is a problem in that detection accuracy is low.

### 1-3-4. Outline of Information Providing System 100-1

The information providing system 100-1 includes the server device 10-1 that is the information providing device and the plant administrator terminal 20 that is used by the plant administrator O. The server device 10-1 receives drawing data on the plant drawing generated by using each of the symbols that indicate the plurality of respective components that constitute the plant, accepts selection of an arbitrary component from among the plurality of components from the plant administrator terminal 20, detects, on the basis of the symbol pattern of the symbol that indicates the selected component, from each of the symbols included in the plant drawing, the symbols having symbol patterns that are matched or similar each other, and transmits the symbol detection information related to the detected symbol to the plant administrator terminal 20. At this time, the server device 10-1 transmits, as the symbol detection information, a symbol detection drawing that is a highlighted plant drawing obtained by coloring the detected symbols and a symbol detection list that indicates a list of the detected symbols, and causes the monitor screen of the plant administrator terminal 20 to display the detection result.

### 1-3-5. Effects

The information providing system 100-1 is able to efficiently detect the symbols of the instruments and the materials from the plant drawing that is used for construction, operation, and maintenance of the plant, and provide the detected symbols to the plant administrator O, a plant engineer, a plant construction business person, or the like who is a user of the plant drawing. Furthermore, in the information providing system 100-1, it is possible to implement pattern extraction with further high accuracy as compared to a symbol detection technology that uses only the machine learning model.

As described above, in the information providing system 100-1, it is possible to efficiently provide the information related to the symbols from the drawing that is related to the plant, so that it is possible to expect to contribute to a development of the plant related technology whose market is expanding.

### 2. Configuration of Each Device in Information Providing System 100-1 and Process Performed by Each Device

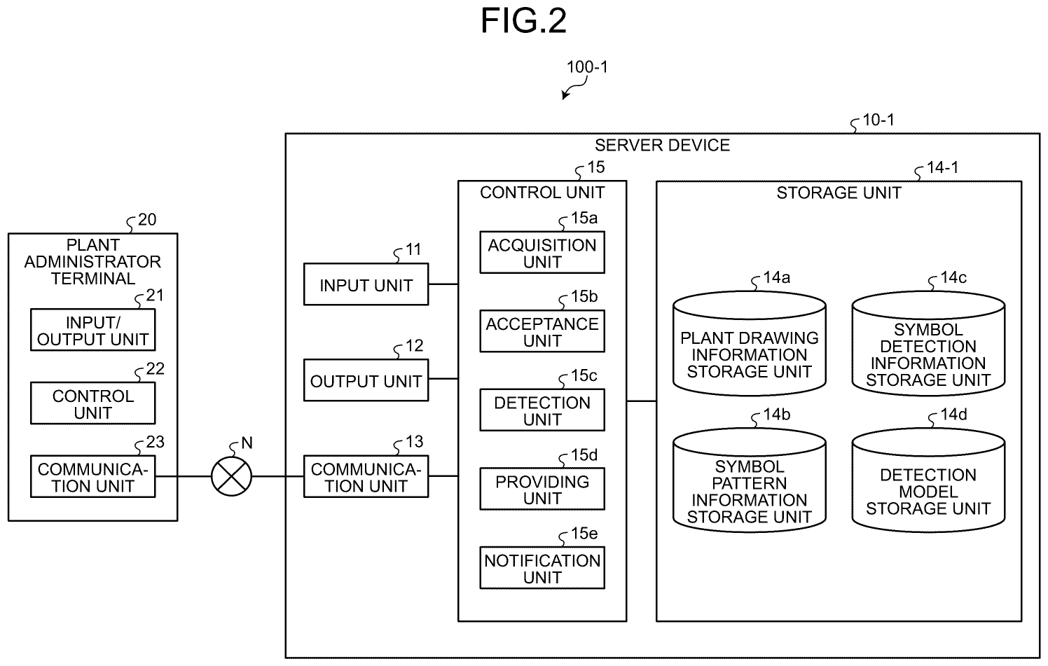

A configuration example and a process example of each of the devices included in the information providing system 100-1 illustrated in FIG. 1 will be described with reference to FIG. 2 to FIG. 9. In a description below, a configuration example of the entire information providing system 100-1 according to the first embodiment is described, and then, both a configuration example and a process example of the server device 10-1 and both a configuration example and a process example of the plant administrator terminal 20 will be described in detail.

### 2-1. Configuration Example of Entire Information Providing System 100-1

The configuration example of the entire information providing system 100-1 illustrated in FIG. 1 will be described with reference to FIG. 2. FIG. 2 is a block diagram illustrating the configuration example of each of the devices included in the information providing system 100-1 according to the first embodiment. As illustrated in FIG. 2, the information providing system 100-1 includes the server device 10-1 that is an information providing device and the plant administrator terminal 20 that is a user terminal. The server device 10-1 is connected to the plant administrator terminal 20 by the communication network N that is implemented by the Internet, a dedicated line, or the like, so as to be able to communicate each other. Furthermore, the server device 10-1 is installed in a cloud environment, an on-premise environment, an edge environment, or the like.

### 2-2. Configuration Example and Process Example of Server Device 10-1

A configuration example and a process example of the server device 10-1 illustrated in FIG. 1 will be described with reference to FIG. 2. The server device 10-1 includes an input unit 11, an output unit 12, a communication unit 13, a storage unit 14-1, and a control unit 15. In the following, the configuration example and the process example of the server device 10-1 will be described, and, in addition, the plant administrator terminal 20 is also able to perform the same process as that performed by the server device 10-1. In other words, the information providing system 100-1 is also able to be implemented by only the plant administrator terminal 20.

### 2-2-1. Input Unit 11

The input unit 11 manages an input of various kinds of information with respect to the server device 10-1. For example, the input unit 11 is implemented by a mouse, a keyboard, or the like, and receives an input of setting information or the like with respect to the server device 10-1.

### 2-2-2. Output Unit 12

The output unit 12 manages an output of various kinds of information from the server device 10-1. For example, the output unit 12 is implemented by a display, or the like, and outputs the setting information or the like stored in the server device 10-1.

### 2-2-3. Communication Unit 13

The communication unit 13 manages data communication with the other devices. For example, the communication unit 13 performs data communication with each of the communication devices by way of a router or the like. Furthermore, the communication unit 13 is able to perform data communication with a terminal that is used by an operator (not illustrated).

### 2-2-4. Storage Unit 14-1

The storage unit 14-1 stores therein various kinds of information that is referred when the control unit 15 is operated, and various kinds of information that have been acquired when the control unit 15 is operated. The storage unit 14-1 includes a plant drawing information storage unit 14a, a symbol pattern information storage unit 14b, a symbol detection information storage unit 14c, and a detection model storage unit 14d. Here, the storage unit 14-1 may be implemented by, for example, a semiconductor memory device, such as a random access memory (RAM) or a flash memory, or a storage device, such as a hard disk or an optical disk. Furthermore, in the example illustrated in FIG. 2, the storage unit 14-1 is installed in the server device 10-1; however, the storage unit 14-1 may be installed outside the server device 10-1, or a plurality of storage units may be installed.

### 2-2-4-1. Plant Drawing Information Storage Unit 14a

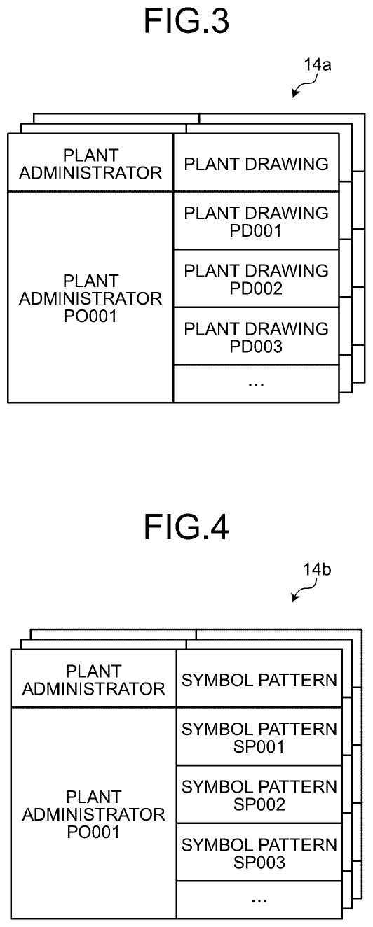

The plant drawing information storage unit 14a stores therein plant drawing information. For example, the plant drawing information storage unit 14a stores therein the plant drawing information that has been acquired by an acquisition unit 15a that will be described later and that is included in the control unit 15. In the following, one example of the data stored by the plant drawing information storage unit 14a will be described with reference to FIG. 3. FIG. 3 is a diagram illustrating one example of the plant drawing information storage unit 14a included in the server device 10-1 according to the first embodiment. In the example illustrated in FIG. 3, the plant drawing information storage unit 14a includes items, such as a “plant administrator” and a “plant drawing”.

The “plant administrator” indicates the identification information for identifying a user who uses the plant drawing, and is, for example, an identification number or an identification sign assigned to the plant administrator O. The “plant drawing” is drawing data on the drawing related to the plant, and is, for example, digital data on a building diagram, a layout drawing, a P&ID, an ECWD, an IBD, a single line connection diagram, a soft logic drawing, or the like of the plant.

In other words, FIG. 3 illustrates an example in which, data corresponding to {“plant drawing PD001”, “plant drawing PD002”, “plant drawing PD003”, and . . . } is stored as the “plant drawing” received from the plant administrator terminal 20 that is used by the plant administrator O identified by a “plant administrator PO001” in the plant drawing information storage unit 14a.

### 2-2-4-2. Symbol Pattern Information Storage Unit 14b

The symbol pattern information storage unit 14b stores therein the symbol pattern information. For example, the symbol pattern information storage unit 14b stores therein the symbol pattern that has been specified by a detection unit 15c that will be described later and that is included in the control unit 15. In the following, one example of the data stored in the symbol pattern information storage unit 14b will be described with reference to FIG. 4. FIG. 4 is a diagram illustrating one example of the symbol pattern information storage unit 14b included in the server device 10-1 according to the first embodiment. In the example illustrated in FIG. 4, the symbol pattern information storage unit 14b includes items, such as the “plant administrator” and a “symbol pattern”.

The “plant administrator” indicates the identification information for identifying the user who uses the plant drawing, and is, for example, the identification number and the identification sign assigned to the plant administrator O. The “symbol pattern” is the identification information for identifying the shape of a symbol, and is, for example, a diagram, a line type, a color, or the like of the symbol.

In other words, FIG. 4 illustrates an example in which data corresponding to {“symbol pattern SP001”, “symbol pattern SP002”, “symbol pattern SP003”, and . . . } as the “symbol pattern” of the symbol that has been accepted by the plant administrator terminal 20 that is used by the plant administrator O identified by the “plant administrator PO001” in the symbol pattern information storage unit 14b.

### 2-2-4-3. Symbol Detection Information Storage Unit 14c

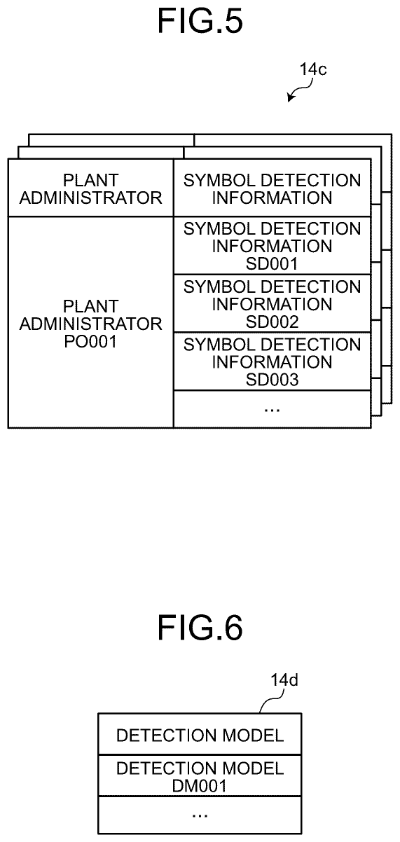

The symbol detection information storage unit 14c stores therein the symbol detection information. For example, the symbol detection information storage unit 14c stores therein the symbol detection information that has been generated by the detection unit 15c that will be described later and that is included in the control unit 15. In the following, one example of the data stored by the symbol detection information storage unit 14c will be described with reference to FIG. 5. FIG. 5 is a diagram illustrating one example of the symbol detection information storage unit 14c included in the server device 10-1 according to the first embodiment. In the example illustrated in FIG. 5, the symbol detection information storage unit 14c includes items, such as the “plant administrator” and the “symbol detection information”.

The “plant administrator” indicates the identification information for identifying the user who uses the plant drawing, and is, for example, the identification number and the identification sign assigned to the plant administrator O. The “symbol detection information” is information (symbol detection result) related to the symbol that has been detected by the detection unit 15c, and is, for example, a symbol detection drawing that is a highlighted plant drawing obtained by coloring the detected symbol, a symbol detection list that indicates a list of the detected symbols, and the like.

In other words, FIG. 5 illustrates an example in which data corresponding to {“symbol detection information SD001”, “symbol detection information SD002”, “symbol detection information SD003”, and . . . } is stored as the “symbol detection information” on the symbol accepted by the plant administrator terminal 20 that is used by the plant administrator O identified by the “plant administrator PO001” in the symbol detection information storage unit 14c.

### 2-2-4-4. Detection Model Storage Unit 14d

The detection model storage unit 14d stores therein a detection model DM. For example, the detection model storage unit 14d stores therein the detection model DM that is used by a notification unit 15e that will be described later and that is included in the control unit 15. In the following, one example of the data stored in the detection model storage unit 14d will be described with reference to FIG. 6. FIG. 6 is a diagram illustrating one example of the detection model storage unit 14d included in the server device 10-1 according to the first embodiment. In the example illustrated in FIG. 6, the detection model storage unit 14d includes an item, such as a “detection model”.

The “detection model” is model data on a machine learning model, and is data that includes, for example, execution data, a model parameter, a hyper parameter, and the like that are used to perform an algorithm for the detection model DM.

In other words, FIG. 6 illustrates an example in which the data corresponding to {“detection model DM001”, and . . . } is stored in the detection model storage unit 14d as the model data on the detection model DM that is used by the notification unit 15e.

### 2-2-5. Control Unit 15

The control unit 15 manages the overall control of the server device 10-1. The control unit 15 includes the acquisition unit 15a, an acceptance unit 15b, the detection unit 15c, a providing unit 15d, and the notification unit 15e. Here, the control unit 15 may be implemented by, for example, an electronic circuit, such as a central processing unit (CPU) or a micro processing unit (MPU), or an integrated circuit, such as an application specific integrated circuit (ASIC) or a field programmable gate array (FPGA).

### 2-2-5-1. Acquisition Unit 15a

The acquisition unit 15a performs a plant drawing information acquisition process. The acquisition unit 15a acquires a drawing that is used for construction, operation, and maintenance of the plant. For example, the acquisition unit 15a acquires a plant drawing that is a configuration diagram that is generated by using the plurality of symbols that indicate the plurality of respective components constituting the plant. At this time, the acquisition unit 15a acquires, as the plant drawing, the drawing data that includes the plurality of symbols that have been generated by the digital data. Furthermore, the acquisition unit 15a acquires the plant drawing information that has been transmitted from the plant administrator terminal 20 corresponding to the user terminal and that is the drawing data on the plant drawing selected by the plant administrator O who is the user. Moreover, the acquisition unit 15a stores the acquired plant drawing information in the plant drawing information storage unit 14a.

Furthermore, the acquisition unit 15a performs the plant drawing information displaying process. For example, the acquisition unit 15a displays the acquired plant drawing that is used for construction, operation, and maintenance of the plant. At this time, the acquisition unit 15a causes the plant administrator terminal 20 to display the plant drawing.

As a specific example, the acquisition unit 15a acquires {“plant drawing PD001”, “plant drawing PD002”, “plant drawing PD003”, and . . . } as the plant drawing information acquired from the plant administrator terminal 20 that is used by the plant administrator O identified by the “plant administrator PO001”, stores the acquired plant drawing information in the plant drawing information storage unit 14a, and causes the plant administrator terminal 20 to display the plant drawing.

### 2-2-5-2. Acceptance Unit 15b

The acceptance unit 15b performs a symbol selection information acceptance process. For example, the acceptance unit 15b accepts the symbol selection information that indicates selection of a desired symbol from among the plurality of symbols included in the displayed plant drawing. At this time, the acceptance unit 15b accepts, as the symbol selection information, the symbol that has been selected by an operation performed by the plant administrator O on the plant drawing that is displayed on the plant administrator terminal 20. Furthermore, the acceptance unit 15b may store the accepted symbol selection information in the storage unit 14-1.

Furthermore, the acceptance unit 15b may also accept, as a detection condition that is used at the time of detection of a symbol, the symbol angle information related to the orientation of a symbol, the symbol text information related to the text that is attached to the symbol, the symbol shape information related to a diagram, a line type, a color, or the like of the symbol, or the like.

As a specific example, as a result of an arbitrary control instrument “FC7100” included in the plant drawing that is displayed on the monitor screen of the plant administrator terminal 20 being selected by a click operation performed by the plant administrator O, the acceptance unit 15b accepts, as the symbol selection information received from the plant administrator terminal 20, “FC7100-1” that is the identification information on the symbol associated with the selected control instrument “FC7100”, “plant drawing PD001 (1, 1)” that is the positional information on the position in the plant drawing, and the like.

Furthermore, the acceptance unit 15b accepts, as the detection condition that is used at the time of detection of a symbol, {symbol angle information: “detect exact matched symbols”, symbol text information: “detect a symbol including a text”, symbol shape information: “detect symbols with exact matched diagram”/“detect symbols with exact matched line type”/“ignore color differences”}, and the like.

### 2-2-5-3. Detection Unit 15c

The detection unit 15c performs a symbol pattern registration process, a symbol angle specifying process, a symbol text specifying process, a symbol detection process, a symbol detection information generating process, and the like.

### Symbol Pattern Registration Process

The detection unit 15c specifies, by using the digital data, at least one of the diagrams, the line type, and the color of the symbol as the pattern of the accepted selection of the symbol. Furthermore, the detection unit 15c stores the specified symbol pattern in the symbol pattern information storage unit 14b.

As a specific example, in the case where “FC7100-1” that is the identification information on the symbol associated with the selected control instrument “FC7100” and the “plant drawing PD001 (1, 1)” that is the positional information on the position in the plant drawing have been accepted, the detection unit 15c registers the symbol pattern by acquiring the plant drawing information on the “plant drawing PD001” from the plant drawing information storage unit 14a, specifying the digital data on the symbol associated with the control instrument “FC7100” from the identification information and the positional information, specifying {diagram: “circle/line segment/square”, line type: “solid line”, color: “green”} as the pattern of the symbol associated with the control instrument “FC7100”, and storing the specified data in the symbol pattern information storage unit 14b.

### Symbol Angle Specifying Process

The detection unit 15c specifies, by using the digital data, a symbol angle that is the orientation of the accepted selection of the symbol. Furthermore, the detection unit 15c may also store the specified symbol angle in the storage unit 14-1.

As a specific example, in the case where “FC7100-1” that is the identification information on the symbol associated with the selected control instrument “FC7100” and the “plant drawing PD001 (1, 1)” that is the positional information on the position in the plant drawing have been accepted, the detection unit 15c acquires the plant drawing information on the “plant drawing PD001” from the plant drawing information storage unit 14a, specifies the digital data on the symbol associated with the control instrument “FC7100” from the identification information and the positional information, specifies {symbol angle: “180°”} as the symbol angle that is the orientation of the symbol associated with the control instrument “FC7100”, and stores the obtained data in the storage unit 14-1.

### Symbol Text Specifying Process

The detection unit 15c specifies, by using the digital data, a symbol text that is the text attached to the accepted selection of the symbol. Furthermore, the detection unit 15c may also store the specified symbol text in the storage unit 14-1.

As a specific example, in the case where “FC7100-1” that is the identification information on the symbol associated with the selected control instrument “FC7100” and the “plant drawing PD001 (1, 1)” that is the positional information on the position in the plant drawing have been accepted, the detection unit 15c acquires the plant drawing information on the “plant drawing PD001” from the plant drawing information storage unit 14a, specifies the digital data on the symbol associated with the control instrument “FC7100” from the identification information and the positional information, specifies {symbol text: “FC”/“7100”} as the symbol text that is the text attached to the symbol associated with the control instrument “FC7100”, and stores the obtained data in the storage unit 14-1.

### Symbol Detection Process

The detection unit 15c detects a symbol from the plurality of symbols that are included in the plant drawing on the basis of the pattern of the accepted selection of the symbol. For example, the detection unit 15c detects, from the displayed plant drawing, all of the symbols having the shape that is matched with the registered pattern including the symbol that has been used for the selection. Furthermore, the detection unit 15c detects all of the symbols having the matched orientation from among the plurality of symbols that are included in the plant drawing. Furthermore, the detection unit 15c detects all of the symbols having the matched text from among the plurality of symbols that are included in the plant drawing.

As a specific example, in the case where {symbol shape information: “detect symbols with exact matched diagram”/“detect symbols with exact matched line type”/“ignore color differences”} has been accepted as the detection condition that is used at the time of detection of the symbol associated with the control instrument “FC7100” included in the “plant drawing PD001”, the detection unit 15c acquires the plant drawing information on the “plant drawing PD001” from the plant drawing information storage unit 14a, acquires the symbol pattern {diagram: “circle/line segment/square”, line type: “solid line”, color: “green”} associated with the control instrument “FC7100” from the symbol pattern information storage unit 14b, searches the plant drawing information on the “plant drawing PD001”, and detects the symbols having the matched symbol pattern {diagram: “circle/line segment/square”, line type: “solid line”}.

Furthermore, in the case where {symbol angle information: “detect exact matched symbols”} has been accepted as the detection condition that is used at the time of detection of the symbol associated with the control instrument “FC7100” included in the “plant drawing PD001”, the detection unit 15c further detects the symbol having the symbol angle of “180°” from among the symbols having the matched symbol pattern.

Furthermore, in the case where {symbol text information: “detect a symbol including a text”} has been detected as the detection condition that is used at the time of detection of the symbol associated with the control instrument “FC7100” included in the “plant drawing PD001”, the detection unit 15c further detects the symbol having the symbol text of “FC”/“7100” from among the symbols having the matched symbol pattern.

### Symbol Detection Information Generating Process

The detection unit 15c generates the symbol detection information that is the detection result related to the detected symbols. For example, the detection unit 15c generates, as the symbol detection information, the symbol detection drawing that is the plant drawing in which the detected symbols are highlighted. Furthermore, the detection unit 15c generates the symbol detection list that is a list of the detected symbols. Furthermore, the detection unit 15c stores the generated symbol detection information in the symbol detection information storage unit 14c.

As a specific example of the symbol detection drawing, the detection unit 15c acquires the plant drawing information on the “plant drawing PD001” from the plant drawing information storage unit 14a, generates, as the symbol detection drawing, the plant drawing information on the “plant drawing PD001” that is highlighted by coloring the symbol associated with the detected control instrument “FC7100” in blue, and stores the obtained data in the symbol detection information storage unit 14c.

As a specific example of the symbol detection list, the detection unit 15c generates, as the symbol detection list, the identification information {“FC7100-1”, “FC7100-2”, . . . , and “FC7100-6”} on the detected control instrument “FC7100”, and stores the generated data in the symbol detection information storage unit 14c.

### 2-2-5-4. Providing Unit 15d

The providing unit 15d performs the symbol detection information transmission process. For example, the providing unit 15d provides the symbol detection information that is the detection result related to the symbol that has been detected by the detection unit 15c to the plant administrator O by transmitting the symbol detection information to the plant administrator terminal 20.

As a specific example, the providing unit 15d transmits, as the symbol detection information, to the plant administrator terminal 20 that is used by the plant administrator O identified by the “plant administrator PO001”, the symbol detection drawing that is the plant drawing information on the “plant drawing PD001” that has been highlighted by coloring the symbol associated with the detected control instrument “FC7100” in blue and the symbol detection list that is the identification information {“FC7100-1”, “FC7100-2”, . . . , and “FC7100-6”} on the detected control instrument “FC7100”.

### 2-2-5-5. Notification Unit 15e

The notification unit 15e performs an output result acquisition process, a detection mistake notification process, and the like.

### Output Result Acquisition Process

The notification unit 15e acquires an output result by using a trained machine learning model that outputs the symbol included in the plant drawing in accordance with an input of each of the digital data on the plant drawing and the symbol pattern.

As a specific example, the notification unit 15e inputs the plant drawing information on the “plant drawing PD001” and the symbol pattern {diagram: “circle/line segment/square”, line type: “solid line”} to the detection model DM included in the detection model storage unit 14d, and acquires {“FC7100-1”, “FC7100-2”, . . . , “FC7100-6”, “FC7100-7”} that is an output result of the detection model DM.

### Detection Mistake Notification Process

The notification unit 15e notifies the plant administrator O of a detection omission or erroneous detection of the symbol obtained by using the output result of the trained machine learning model.

As a specific example, the notification unit 15e compares the symbol detection list {“FC7100-1”, “FC7100-2”, . . . , and “FC7100-6”} of the control instrument “FC7100” that has been detected by the detection unit 15c with {“FC7100-1”, “FC7100-2”, . . . , “FC7100-6”, and “FC7100-7”} that are the output result of the detection model DM, determines a probability of a detection omission of the symbol associated with the control instrument “FC7100” that is the identification information “FC7100-7”, generates a message indicating that “There is a possibility of a detection omission.”, or the like as the detection mistake information, and transmits the generated message to the plant administrator terminal 20 that is used by the plant administrator O that is identified by the “plant administrator PO001”.

### 2-3. Configuration Example and Process Example of Plant Administrator Terminal 20

A configuration example and a process example of the plant administrator terminal 20 will be described with reference to FIG. 2. The plant administrator terminal 20 is a terminal that is used by the plant administrator O who manages the plant, and includes an input/output unit 21, a control unit 22, and a communication unit 23.

### 2-3-1. Input/Output Unit 21

The input/output unit 21 manages an input of various kinds of information with respect to the plant administrator terminal 20. For example, the input/output unit 21 is implemented by a mouse, a keyboard, a touch panel, or the like, and receives an input of the setting information and the like with respect to the plant administrator terminal 20. Furthermore, the input/output unit 21 displays various kinds of information received from the plant administrator terminal 20. For example, the input/output unit 21 is implemented by a display or the like, and displays the setting information and the like that are stored in the plant administrator terminal 20.

The input/output unit 21 displays the plant drawing that is browsed by the plant administrator O. Furthermore, the plant drawing in detail will be described later in the section titled (2-3-4. Specific example 1 of display screen displayed on the plant administrator terminal 20). Furthermore, the input/output unit 21 displays a symbol selection screen by which the plant administrator O is able to select a symbol. Furthermore, the symbol selection screen in detail will be described later in the section titled (2-3-5. Specific example 2 of display screen displayed on the plant administrator terminal 20). Furthermore, the input/output unit 21 displays the symbol detection drawing that is browsed by the plant administrator O. Furthermore, the symbol detection drawing in detail will be described later in the section titled (2-3-6. Specific example 3 of display screen displayed on the plant administrator terminal 20).

### 2-3-2. Control Unit 22

The control unit 22 transmits various kinds of information. For example, the control unit 22 transmits the plant drawing information on the plant drawing that has been selected by the plant administrator O to the server device 10-1. Furthermore, the control unit 22 transmits the symbol selection information on the symbol that has been selected by the plant administrator O on the symbol selection screen to the server device 10-1.

The control unit 22 receives various kinds of information. For example, the control unit 22 receives the symbol detection information including the symbol detection drawing, the symbol detection list, and the like that are displayed on the input/output unit 21 from the server device 10-1. Furthermore, the control unit 22 receives, from the server device 10-1, the detection mistake information that is displayed on the input/output unit 21, that indicates a detection omission or erroneous detection of a symbol, and that is notified to the plant administrator O.

### 2-3-3. Communication Unit 23

The communication unit 23 manages data communication performed with the other devices. For example, the communication unit 23 performs data communication with each of the communication devices via a router or the like. Furthermore, the communication unit 23 is able to perform data communication with a terminal that is used by an operator (not illustrated).

### 2-3-4. Specific Example 1 of Display Screen Displayed on Plant Administrator Terminal 20

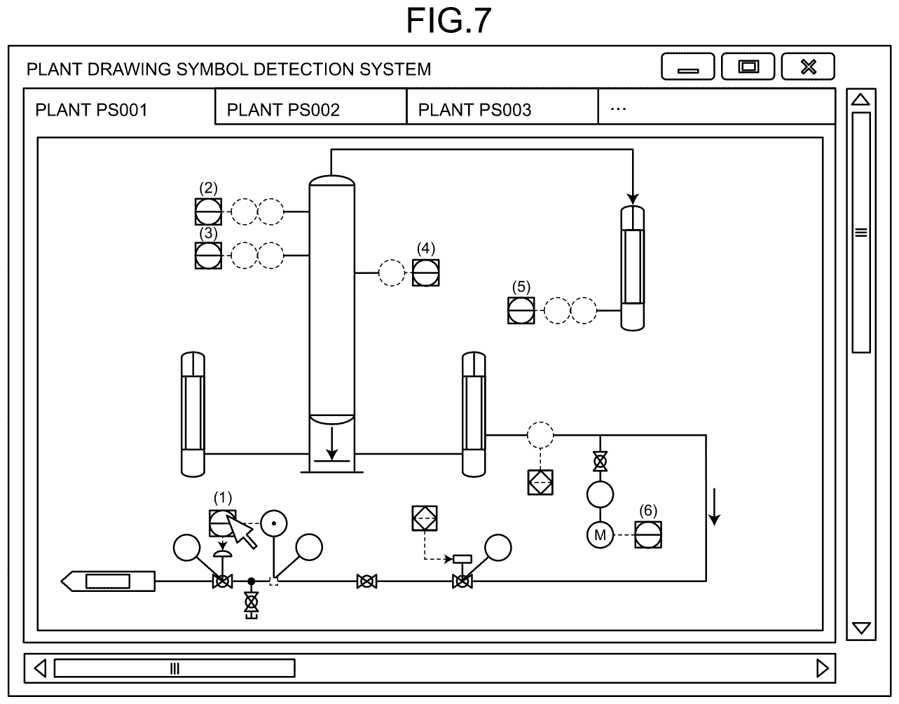

Here, a specific example 1 of a display screen that is output by the input/output unit 21 included in the plant administrator terminal 20 will be described with reference to FIG. 7. FIG. 7 is a diagram illustrating the specific example 1 of the display screen displayed on the plant administrator terminal 20 according to the first embodiment. In the following, a plant drawing that is browsed by the plant administrator O will be described.

### 2-3-4-1. Plant Drawing

As indicated by the example illustrated in FIG. 7, the plant administrator terminal 20 displays, for each plant, the plant drawing that has been generated by the symbols that indicate the respective components included in the plant and generated by the lines that indicate the respective connection elements and that connect the respective components included in the plant. In the example illustrated in FIG. 7, in the plant drawing indicated by the “plant PS001”, the symbols indicating the control instruments that the plant administrator O desires to detect are displayed (see (1) to (6) in FIG. 7).

### 2-3-4-2. Display Format of Symbol

The plant administrator terminal 20 is able to display, as the symbols, not only the symbols each having a different shape, such as a diagram, a line type, a color, or the like, but also symbols each having a different orientation, the symbols each having an attached text, symbols each having a different line thickness, and the like. At this time, the plant administrator terminal 20 is also able to display the plant drawing that indicates the configuration of a three-dimensional plant by depicting the relationship between before and after each of the symbols.

### 2-3-5. Specific Example 2 of Display Screen Displayed on Plant Administrator Terminal 20

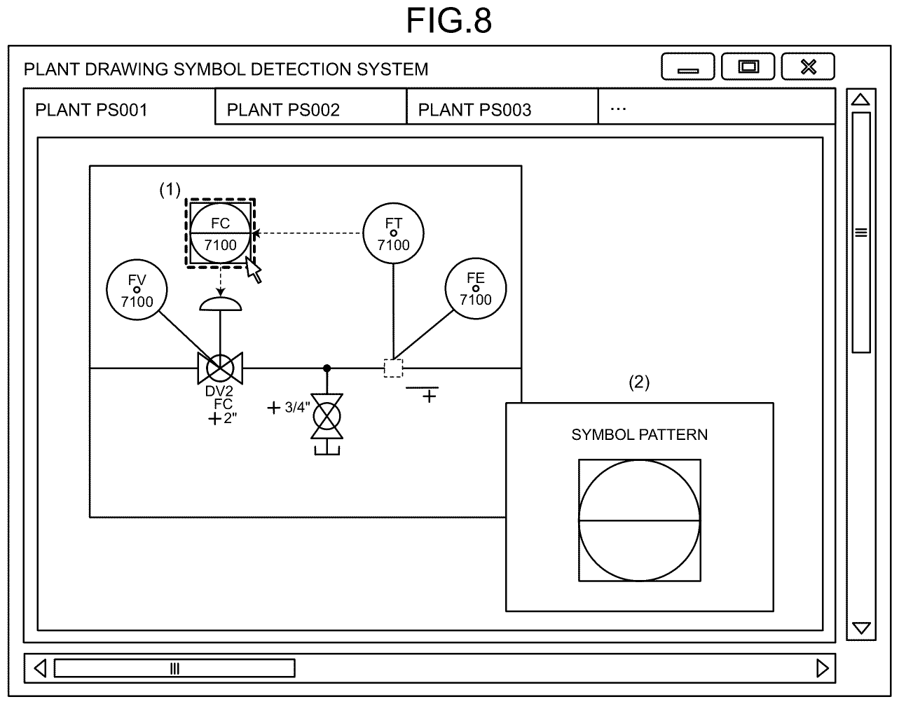

Here, a specific example 2 of the display screen that is output by the input/output unit 21 included in the plant administrator terminal 20 will be described with reference to FIG. 8. FIG. 8 is a diagram illustrating the specific example 2 of the display screen displayed on the plant administrator terminal 20 according to the first embodiment. In the following, the symbol selection screen by which the plant administrator O is able to select a symbol will be described.

### 2-3-5-1. Symbol Selection Screen

As indicated by the example illustrated in FIG. 8, the plant administrator terminal 20 displays the symbol selection screen that enables the plant administrator O to select, on the plant drawing, the symbol that the plant administrator O desires to select. In the example illustrated in FIG. 8, in the plant drawing indicated by the “plant PS001”, the plant administrator terminal 20 displays the plant drawing in which an area around the symbol (see (1) in FIG. 8) indicating the control instrument that the plant administrator O desires to detect has been enlarged. At this time, the plant administrator O is able to select the target symbol by performing a click operation on the symbol that the plant administrator O desires to detect.

Furthermore, the plant administrator terminal 20 displays the symbol pattern (see (2) in FIG. 8) in which the symbol selected by the plant administrator O has been enlarged on the plant drawing. At this time, the plant administrator O is also able to correct the diagram of the displayed symbol pattern, or also able to delete the text attached to the symbol.

### 2-3-5-2. Assignment of Detection Condition

The plant administrator O is able to assign a detection condition that is used at the time of detection of the symbol. For example, the plant administrator O is able to assign, as the detection condition, a matched condition of one of the diagrams, the line types, and the colors that correspond to the symbol patterns, the orientation of each of the symbols, presence or absence of a text attached to a symbol, or the like. In addition, the plant administrator O is also able to assign the detection condition for detecting the symbols when the size of the symbols is exactly matched.

### 2-3-6. Specific Example 3 of Display Screen Displayed on Plant Administrator Terminal 20

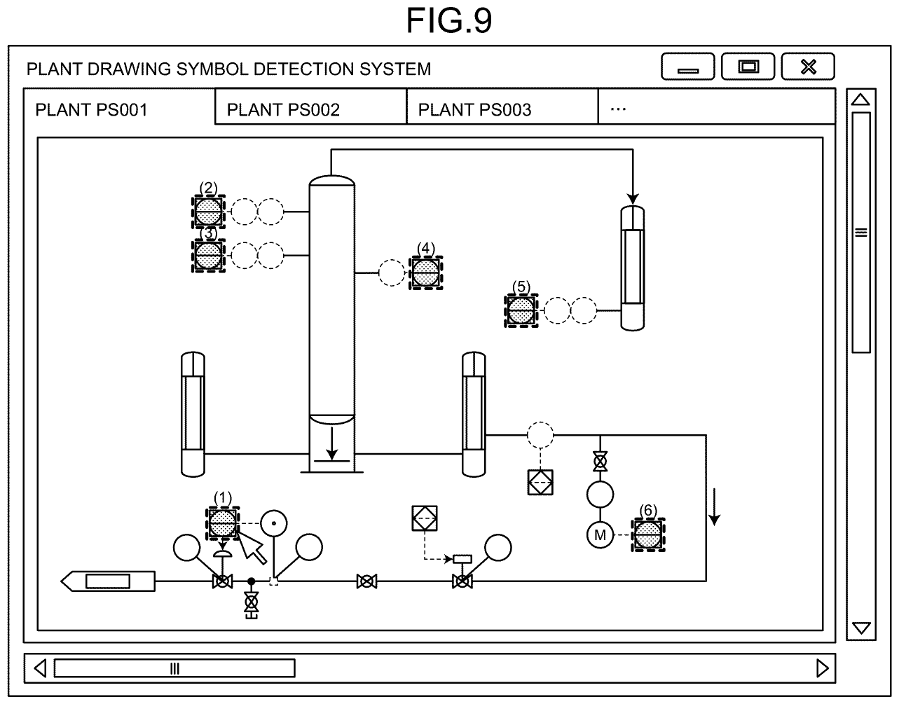

Here, a specific example 3 of the display screen that is output by the input/output unit 21 included in the plant administrator terminal 20 will be described with reference to FIG. 9. FIG. 9 is a diagram illustrating the specific example 3 of the display screen displayed on the plant administrator terminal 20 according to the first embodiment. In the following, the symbol detection drawing that is browsed by the plant administrator O will be described.

### 2-3-6-1. Symbol Detection Drawing

As indicated by the example illustrated in FIG. 9, the plant administrator terminal 20 displays the plant detection drawing that is highlighted by coloring the detected symbol. In the example illustrated in FIG. 9, the plant administrator terminal 20 displays the symbol detection drawing that is the plant drawing in which the symbols of the detected control instruments are highlighted in blue in the plant drawing indicated by the “plant PS001” (see (1) to (6) in FIG. 9). At this time, the plant administrator terminal 20 highlights all of the symbols associated with the control instruments including the symbol associated with the control instrument that has been selected by the plant administrator O (see (1) in FIG. 9).

### 2-3-6-2. Symbol Detection List

The plant administrator terminal 20 is also able to display the symbol detection list that is a list of the detected symbols. For example, the plant administrator terminal 20 is also able to display, as the symbol detection list, the list of the symbols including the identification information and the positional information on the detected symbols.

### 2-3-6-3. Notification of Detection Mistake

The plant administrator terminal 20 is also able to display a detection mistake notification that indicates a possibility of a detection omission of the detected symbol or erroneous detection. For example, the plant administrator terminal 20 is also able to display a message indicating that “There is a possibility of a detection omission.”, or the like as the detection mistake notification.

### 3. Flow of Process Performed in Information Providing System 100-1

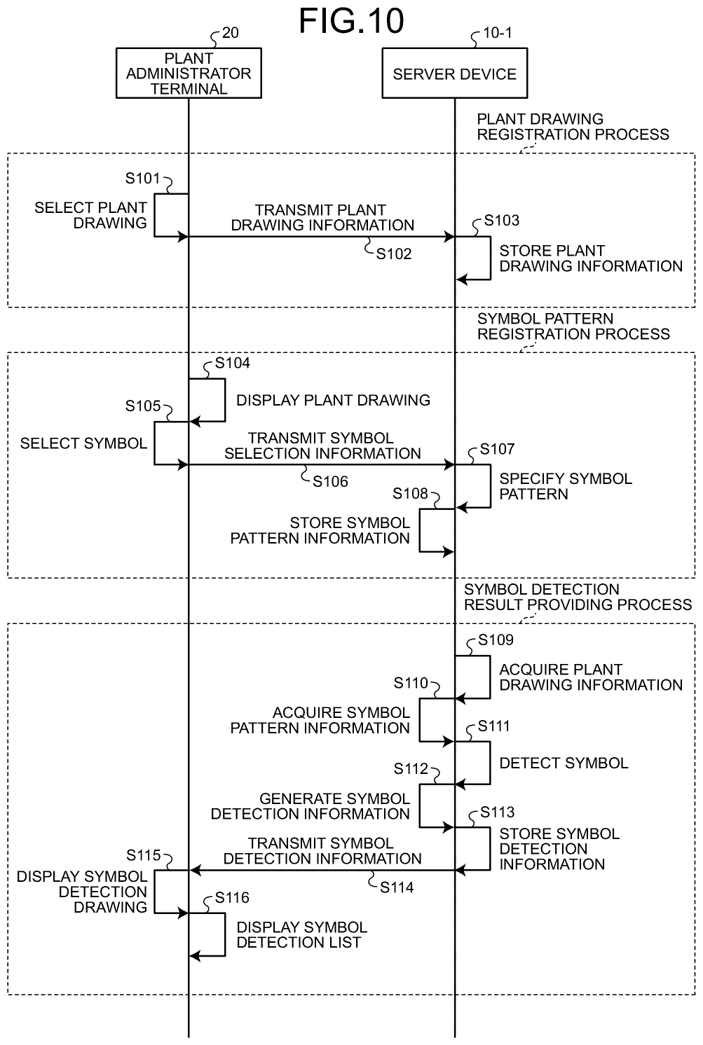

The flow of the process performed in the information providing system 100-1 according to the first embodiment will be described with reference to FIG. 10. FIG. 10 is a sequence diagram illustrating one example of the flow of the process performed in the information providing system 100-1 according to the first embodiment. In the following, explanations will be given in the order of the plant drawing registration process, the symbol pattern registration process, and the symbol detection result providing process. Furthermore, the processes at Steps S101 to S116 may also be performed in different order. Moreover, from among the processes at Steps S101 to S116 described below, there may be a process that is omitted.

### 3-1. Plant Drawing Registration Process

The information providing system 100-1 performs the plant drawing registration process that is indicated by the processes at Steps S101 to S103 described below.

At a first step, the plant administrator terminal 20 performs the plant drawing selection process (Step S101). For example, the plant administrator terminal 20 accepts the plant drawing of the plant that has been selected by the operation performed by the plant administrator O. At a second step, the plant administrator terminal 20 performs the plant drawing information transmission process (Step S102). For example, the plant administrator terminal 20 transmits, to the server device 10-1, the digital data on the plant drawing of the plant that has been selected by the operation performed by the plant administrator O. At a third step, the server device 10-1 performs a plant drawing information storing process (Step S103). For example, the server device 10-1 stores the plant drawing information received from the plant administrator terminal 20 for each of the plant administrators O.

### 3-2. Symbol Pattern Registration Process

The information providing system 100-1 performs the symbol pattern registration process that is indicated by the processes at Steps S104 to S108 described below.

At a first step, the plant administrator terminal 20 performs the plant drawing displaying process (Step S104). For example, the plant administrator terminal 20 displays, on the monitor screen, the plant drawing of the plant that has been selected by an operation performed by the plant administrator O. At a second step, the plant administrator terminal 20 performs the symbol selection process (Step S105). For example, the plant administrator terminal 20 accepts the symbol that has been selected by the operation performed by the plant administrator O on the plant drawing. At a third step, the plant administrator terminal 20 performs the symbol selection information transmission process (Step S106). For example, the plant administrator terminal 20 transmits, to the server device 10-1, the identification information on the symbol that has been selected by the operation performed by the plant administrator O and the positional information on the position of the symbol indicated in the plant drawing. At a fourth step, the server device 10-1 performs the symbol pattern specifying process (Step S107). For example, the server device 10-1 refers to the plant drawing information on the basis of the symbol selection information received from the plant administrator terminal 20, and specifies the symbol pattern from the digital data on the plant drawing information. At a fifth step, the server device 10-1 performs the symbol pattern information storing process (Step S108). For example, the server device 10-1 stores the symbol pattern information including the specified symbol pattern for each of the plant administrator O.

### 3-3. Symbol Detection Result Providing Process

The information providing system 100-1 performs the symbol detection result providing process that is indicated by the processes at Steps S109 to S116 described below.

At a first step, the server device 10-1 performs the plant drawing information acquisition process (Step S109). For example, the server device 10-1 accepts a request for detecting a symbol made by an operation performed by the plant administrator O, searches the stored plant drawing information, and acquires the plant drawing information on the corresponding plant. At a second step, the server device 10-1 performs the symbol pattern information acquisition process (Step S110). For example, the server device 10-1 accepts a request for detecting a symbol made by an operation performed by the plant administrator O, searches the stored symbol pattern information, and acquires the symbol pattern information on the corresponding symbol. At a third step, the server device 10-1 performs the symbol detection process (Step S111). For example, the server device 10-1 searches the acquired plant drawing information, and detects the symbol having the symbol pattern that is matched with the acquired symbol pattern information. At a fourth step, the server device 10-1 performs the symbol detection information generating process (Step S112). For example, the server device 10-1 generates the symbol detection drawing in which the detected symbols are highlighted, and the symbol detection list that indicates a list of the detected symbols. At a fifth step, the server device 10-1 performs the symbol detection information storing process (Step S113). For example, the server device 10-1 stores, for each of the plant administrator O, the symbol detection information that includes the generated symbol detection drawing and the symbol detection list. At a sixth step, the server device 10-1 performs the symbol detection information transmission process (Step S114). For example, the server device 10-1 transmits the symbol detection information that includes the generated symbol detection drawing and the symbol detection list to the plant administrator terminal 20. At a seventh step, the plant administrator terminal 20 performs the symbol detection drawing displaying process (Step S115). For example, the plant administrator terminal 20 displays the symbol detection drawing that is included in the symbol detection information received from the server device 10-1 on the monitor screen. At an eighth step, the plant administrator terminal 20 performs the symbol detection list displaying process (Step S116). For example, the plant administrator terminal 20 displays the symbol detection list that is included in the symbol detection information received from the server device 10-1 on the monitor screen.

### 4. Effect of First Embodiment

Lastly, the effect of the first embodiment will be described. In the following, effects 1 to 5 associated with the process according to the first embodiment will be described.

### 4-1. Effect 1

At a first step, in the above described processes according to the first embodiment, the server device 10-1 receives the plant drawing that has been generated by using each of the symbols that indicate the plurality of respective components that constitute the plant, accepts, from the plant administrator terminal 20, selection of an arbitrary component from among the plurality of components, detects a symbol from among the symbols that are included in the plant drawing on the basis of the symbol pattern of the symbol that indicates the selected component, and transmits the symbol detection information related to the detected symbol to the plant administrator terminal 20. As a result of this, in the processes according to the first embodiment, it is possible to efficiently provide the information related to the symbols that are included in the plant drawing.

### 4-2. Effect 2

At a second step, in the above described process according to the first embodiment, the server device 10-1 receives, as the plant drawing, the drawing data that includes each of the symbols generated by the digital data, accepts an arbitrary component that has been selected by an operation performed by the plant administrator O on the plant drawing that is displayed on the plant administrator terminal 20, specifies, as the pattern of the symbol selected by using the digital data, at least one of the diagrams, the line type, and the color of the symbol, and detects the symbols each having a matched pattern or a similar pattern from among the symbols included in the plant drawing. As a result of this, in the processes according to the first embodiment, it is possible to efficiently provide the information related to the symbols that are included in the plant drawing by detecting the symbols each having a shape that is matched with or similar to the shape of the symbol that has been selected by the plant administrator O.

### 4-3. Effect 3

At a third step, in the above described process according to the first embodiment, the server device 10-1 specifies the orientation of the selected symbol, and detects the symbols having the matched orientation from among the symbols included in the plant drawing. As a result of this, in the process according to the first embodiment, it is possible to efficiently provide the information related to the symbols that are included in the plant drawing by detecting the symbols each having a shape that is matched with or similar to the shape of the symbol that has been selected by the plant administrator O, and also, the symbols each having an orientation that is matched with the orientation of the symbol that has been selected by the plant administrator O.

### 4-4. Effect 4

At a fourth step, in the above described process according to the first embodiment, the server device 10-1 further specifies the text that is attached to the selected symbol, and detects the symbol with the matched text from among the symbols that are included in the plant drawing. As a result of this, in the process according to the first embodiment, it is possible to efficiently provide the information related to the symbols that are included in the plant drawing by detecting the symbols each having a shape that is matched with or similar to the shape of the symbol that has been selected by the plant administrator O, and also, by detecting the symbols each having the text that is matched with the text attached to the symbol selected by the plant administrator O.

### 4-5. Effect 5

At a fifth step, in the above described process according to the first embodiment, the server device 10-1 generates, as the symbol detection information, at least one of the plant drawing, in which the detected symbols are highlighted, and the list of the detected symbols. As a result of this, in the process according to the first embodiment, it is possible to efficiently provide the symbol detection drawing and the symbol detection list as the information related to the symbols that are included in the plant drawing.

### Second Embodiment

In the following, a configuration and a process related to an information providing system 100-2 that is a plant drawing line detection system according to a second embodiment, a configuration and a process related to each of the devices that are included in the information providing system 100-2, and the flow of the processes performed in the information providing system 100-2 will be described in this order and, at the end, effects of the second embodiment will be described. Furthermore, descriptions of the configuration and the processes that are the same as those described in the first embodiment will be omitted.

### 1. Configuration and Process Related to Information Providing System 100-2

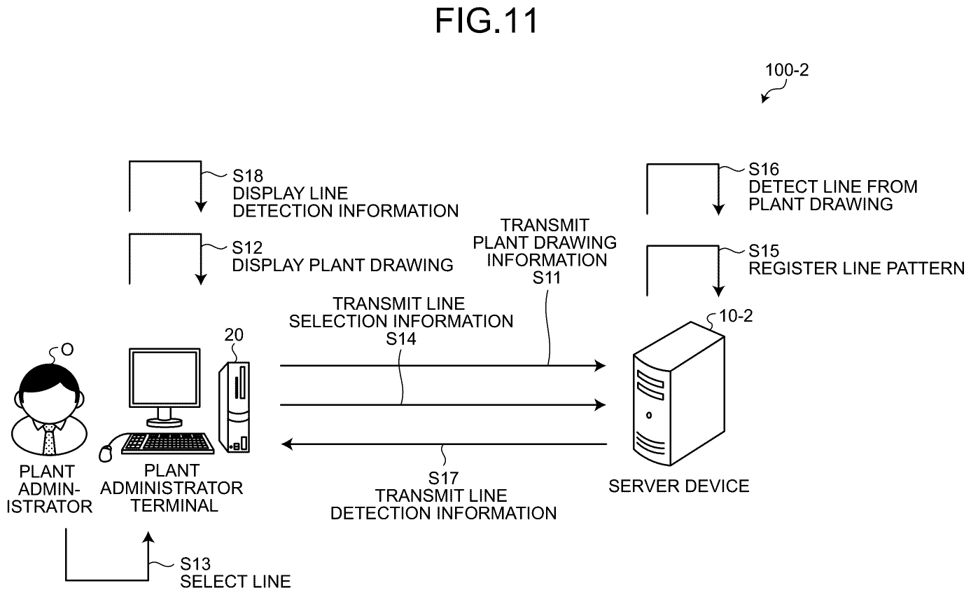

A configuration and a process related to an information providing system 100-2 according to the second embodiment will be described with reference to FIG. 11. FIG. 11 is a diagram illustrating a configuration example and a process example of the information providing system 100-2 according to the second embodiment. In a description below, the configuration example of the entire information providing system 100-2, the process example of the information providing system 100-2, and the effects of the information providing system 100-2 will be described.

### 1-1. Configuration Example of Entire Information Providing System 100-2

The configuration example of the entire information providing system 100-2 according to the second embodiment will be described. The information providing system 100-2 includes a server device 10-2 that is an information providing device (plant drawing line detection device), and the plant administrator terminal 20 that is used by the plant administrator O. Here, the server device 10-2 and the plant administrator terminal 20 are connected via a predetermined communication network (network) (not illustrated) so as to be able to communicate each other in a wired or wireless manner. Furthermore, for the predetermined communication network, it is possible to use various communication networks including the Internet, a dedicated line, or the like. Moreover, in the information providing system 100-2 illustrated in FIG. 11, two or more of the server devices 10-2 or two or more of the plant administrator terminals 20 may be included.

### 1-2. Process Example of Entire Information Providing System 100-2

A process example of the entire information providing system 100-2 according to the second embodiment will be described. Furthermore, the processes performed at Steps S11 to S17 may also be in different order. Moreover, from among the processes performed at Steps S11 to S17 described below, there may be a process that is omitted.

### 1-2-1. Plant Drawing Information Transmission Process

At a first step, the plant administrator terminal 20 transmits the plant drawing information to the server device 10-2 (Step S11). For example, the plant administrator terminal 20 transmits the plant drawing information that has been selected by an operation performed by the plant administrator O to the server device 10-2. At this time, the server device 10-2 receives the plant drawing information and stores the received plant drawing information.

### 1-2-2. Plant Drawing Displaying Process

At a second step, the plant administrator terminal 20 displays the plant drawing (Step S12). For example, the plant administrator terminal 20 displays the plant drawing that has been selected by the operation performed by the plant administrator O on the monitor screen.

### 1-2-3. Line Selection Process

At a third step, the plant administrator O selects a line by operating the plant administrator terminal 20 (Step S13). For example, the plant administrator O selects the line associated with piping by performing a click operation on the line associated with the piping included in the plant drawing that is displayed on a monitor screen of the plant administrator terminal 20.

Here, the line indicates a sign that indicates a connection element that connects the components included in the plant and that is illustrated in the plant drawing. Furthermore, the connection element mentioned here indicates piping (e.g.: piping through which a fluid flows) or wiring (e.g.: wiring through which electricity flows) that connects the plant instruments that constitutes the plant, the plant facilities, and the like.

### 1-2-4. Line Selection Information Transmission Process

At a fourth step, the plant administrator terminal 20 transmits line selection information to the server device 10-2 (Step S14). For example, the plant administrator terminal 20 transmits identification information on the line associated with the piping selected by the plant administrator O or positional information on the position of the line illustrated in the plant drawing to the server device 10-2.

### 1-2-5. Line Pattern Registration Process

At a fifth step, the server device 10-2 registers a line pattern (Step S15). For example, the server device 10-2 acquires the plant drawing information on the basis of the line selection information received from the plant administrator terminal 20, and specifies the line pattern from the digital data on the line associated with the corresponding piping. At this time, the server device 10-2 stores the specified line pattern as line pattern information.

Here, the line pattern indicates the identification information for identifying the shape of a line, and is, for example, a thickness, a line type, a color, or the like of the line.

### 1-2-6. Line Detection Process

At a sixth step, the server device 10-2 detects the line from the plant drawing (Step S16). For example, the server device 10-2 searches the acquired plant drawing information, and detects the line having the line pattern that is matched with or similar to the specified line pattern. At this time, the server device 10-2 generates line detection information that includes a line detection drawing that is a highlighted plant drawing obtained by coloring the detected line, and stores the generated line detection information. Furthermore, the server device 10-2 generates the line detection information that includes a line detection list that indicates a list of the detected lines, and stores the generated line detection information.

The server device 10-2 may detect the line by using the detection model DM that is the machine learning model, and, in the case where a detection mistake, such as a detection omission or erroneous detection, has been made in the line detection information, the server device 10-2 may notify the plant administrator O of the detection mistake.

### 1-2-7. Line Detection Information Transmission Process

At a seventh step, the server device 10-2 transmits the line detection information to the plant administrator terminal 20 (Step S17). For example, the server device 10-2 transmits the line detection information that includes the line detection drawing and the line detection list to the plant administrator terminal 20.

### 1-2-8. Line Detection Information Displaying Process

At an eighth step, the plant administrator terminal 20 displays the line detection information (Step S18). For example, the plant administrator terminal 20 displays the line detection drawing that is included in the received line detection information on the monitor screen. Furthermore, the plant administrator terminal 20 may also display the line detection list that is included in the received line detection information on the monitor screen.

### 1-3. Overall Effect of Information Providing System 100-2

In the following, a point at issue of a reference technology will be described, and then, the effect of the information providing system 100-2 will be described.

### 1-3-1. Point at Issue of Reference Technology

In the technologies of the reference technology 1 and the reference technology 2 described above in the first embodiment, there is a problem in that it is difficult to register the pattern of the desired line from among the plurality of lines that are present in the plant drawing that is used for construction, operation, and maintenance of the plant, detect all of the lines each having a shape or the like that is matched with the shape or the like of the registered pattern from the plant drawing, and provide the detected lines. Furthermore, there is also a known detection technology for detecting a line from a plant drawing, such as a P&ID, generated by the two-dimensional CAD by using a machine learning model, but there is a problem in that detection accuracy is low.

1-3-2. Outline of Information Providing System 100-2

The information providing system 100-2 includes the server device 10-2 that is the information providing device and the plant administrator terminal 20 that is used by the plant administrator O. The server device 10-2 receives drawing data on the plant drawing generated by using each of the lines that indicate a plurality of respective connection elements each of which connects the components that constitute the plant, accepts selection of an arbitrary connection element from among the plurality of connection elements from the plant administrator terminal 20, detects, on the basis of a line pattern of the line that indicates the selected connection element, from each of the lines included in the plant drawing, the lines each having a matched or a similar line pattern, and transmits the line detection information related to the detected line to the plant administrator terminal 20. At this time, the server device 10-2 transmits, as the line detection information, a line detection drawing that is a highlighted plant drawing obtained by coloring the detected lines and a line detection list that indicates a list of the detected lines, and causes the monitor screen of the plant administrator terminal 20 to display the detection result.

### 1-3-3. Effect

The information providing system 100-2 is able to efficiently detect the lines of the piping and the signal lines from the plant drawing that is used for construction, operation, and maintenance of the plant, and provide the detected lines to the plant administrator O, a plant engineer, a plant construction business person, or the like who is a user of the plant drawing. Furthermore, in the information providing system 100-2, it is possible to implement pattern extraction with further high accuracy as compared to a line detection technology that uses only the machine learning model.

As described above, in the information providing system 100-2, it is possible to efficiently provide the information related to the lines from the drawing that is related to the plant, so that it is possible to expect to contribute to a development of the plant related technology whose market is expanding.

### 2. Configuration of Each Device in Information Providing System 100-2 and Process Performed by Each Device

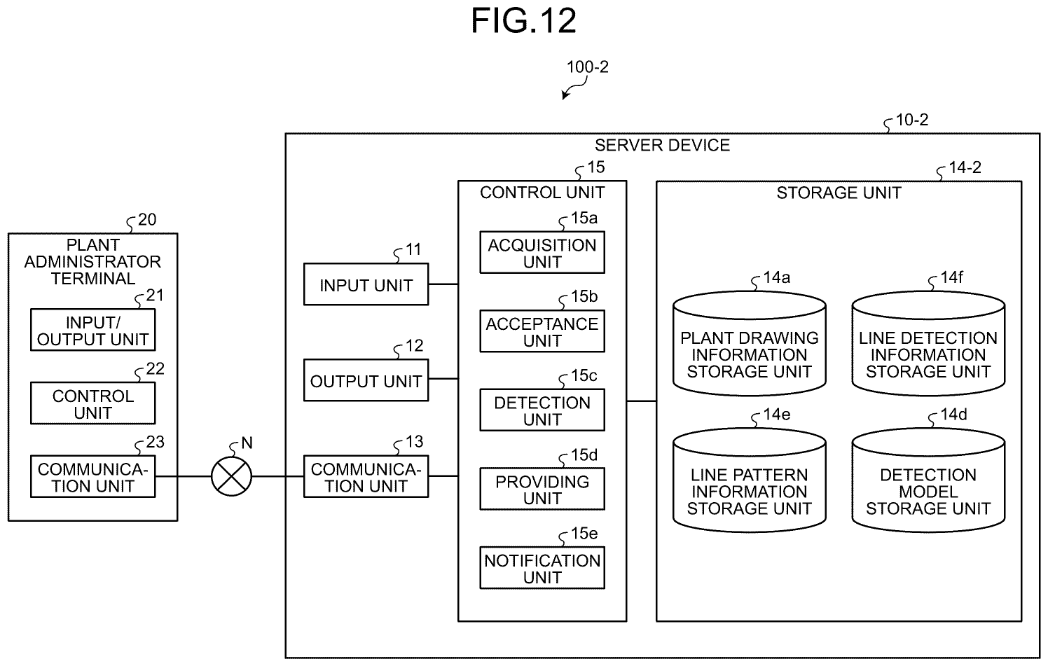

A configuration example and a process example of each of the devices included in the information providing system 100-2 illustrated in FIG. 11 will be described with reference to FIG. 12 to FIG. 17. In a description below, a configuration example of the entire information providing system 100-2 according to the second embodiment will be described, and then, both a configuration example and a process example of the server device 10-2, and both a configuration example and a process example of the plant administrator terminal 20 will be described in detail.

### 2-1. Configuration Example of Entire Information Providing System 100-2

The configuration example of the entire information providing system 100-2 illustrated in FIG. 11 will be described with reference to FIG. 12. FIG. 12 is a block diagram illustrating the configuration example of each of the devices included in the information providing system 100-2 according to the second embodiment. As illustrated in FIG. 12, the information providing system 100-2 includes the server device 10-2 that is the information providing device and the plant administrator terminal 20 that is the user terminal. The server device 10-2 is connected to the plant administrator terminal 20 by the communication network N that is implemented by the Internet, a dedicated line, or the like, so as to be able to communicate each other. Furthermore, the server device 10-2 is installed in a cloud environment, an on-premise environment, an edge environment, or the like.

### 2-2. Configuration Example and Process Example of Server Device 10-2

A configuration example and a process example of the server device 10-2 illustrated in FIG. 11 will be described with reference to FIG. 12. The server device 10-2 includes the input unit 11, the output unit 12, the communication unit 13, a storage unit 14-2, and the control unit 15. In the following, the configuration example and the process example of the server device 10-2 will be described, and, in addition, the plant administrator terminal 20 is also able to perform the same process as that performed by the server device 10-2. In other words, the information providing system 100-2 is also able to be implemented by only the plant administrator terminal 20. Furthermore, the configuration example and the process example of each of the input unit 11, the output unit 12, and the communication unit 13 are the same as those described in the first embodiment; therefore, descriptions thereof will be omitted.

### 2-2-1. Storage Unit 14-2

The storage unit 14-2 stores therein various kinds of information that is referred when the control unit 15 is operated, and various kinds of information that have been acquired when the control unit 15 is operated. The storage unit 14-2 includes the plant drawing information storage unit 14a, a line pattern information storage unit 14e, a line detection information storage unit 14f, and the detection model storage unit 14d. Here, the storage unit 14-2 may be implemented by, for example, a semiconductor memory device, such as a RAM or a flash memory, or a storage device, such as a hard disk or an optical disk. Furthermore, in the example illustrated in FIG. 12, the storage unit 14-2 is installed in the server device 10-2; however, the storage unit 14-2 may be installed outside the server device 10-2, or a plurality of storage units may be installed.

### 2-2-1-1. Plant Drawing Information Storage Unit 14a

The plant drawing information storage unit 14a stores therein the plant drawing information. Moreover, the plant drawing information stored in the plant drawing information storage unit 14a is the same as that described in the first embodiment; therefore, the description of the plant drawing information will be omitted.

### 2-2-1-2. Line Pattern Information Storage Unit 14e

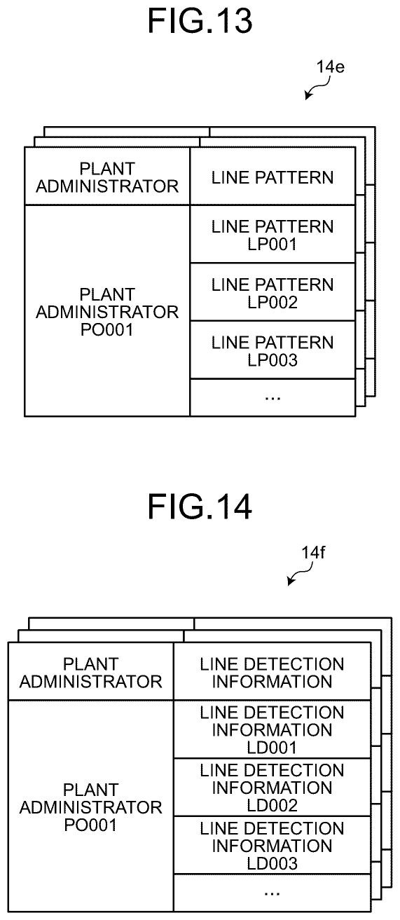

The line pattern information storage unit 14e stores therein the line pattern information. For example, the line pattern information storage unit 14e stores therein the line pattern that has been specified by the detection unit 15c that will be described later and that is included in the control unit 15. Here, one example of the data stored in the line pattern information storage unit 14e will be described with reference to FIG. 13. FIG. 13 is a diagram illustrating one example of the line pattern information storage unit 14e included in the server device 10-2 according to the second embodiment. In the example illustrated in FIG. 13, the line pattern information storage unit 14e includes items, such as a “plant administrator” and a “line pattern”.

The “plant administrator” indicates the identification information for identifying a user who uses the plant drawing, and is, for example, an identification number or an identification sign assigned to the plant administrator O. The “line pattern” is the identification information for identifying the shape of a line, and is, for example, a thickness, a line type, a color, or the like of the line.

In other words, FIG. 13 illustrates an example in which data corresponding to {“line pattern LP001”, “line pattern LP002”, “line pattern LP003”, and . . . } is stored as the “line pattern” of the line that has been accepted by the plant administrator terminal 20 that is used by the plant administrator O identified by the “plant administrator PO001” in the line pattern information storage unit 14e.

### 2-2-1-3. Line Detection Information Storage Unit 14f

The line detection information storage unit 14f stores therein the line detection information. For example, the line detection information storage unit 14f stores therein the line detection information that has been generated by the detection unit 15c that will be described later and that is included in the control unit 15. In the following, one example of the data stored in the line detection information storage unit 14f will be described with reference to FIG. 14. FIG. 14 is a diagram illustrating one example of the line detection information storage unit 14f included in the server device 10-2 according to the second embodiment. In the example illustrated in FIG. 14, the line detection information storage unit 14f includes items, such as the “plant administrator” and the “line detection information”.

The “plant administrator” indicates the identification information for identifying the user who uses the plant drawing, and is, for example, the identification number and the identification sign assigned to the plant administrator O. The “line detection information” is information (line detection result) related to the line that has been detected by the detection unit 15c, and is, for example, a line detection drawing that is a highlighted plant drawing obtained by coloring the detected line, a line detection list that indicates a list of the detected lines, and the like.

In other words, FIG. 14 illustrates an example in which data corresponding to {“line detection information LD001”, “line detection information LD002”, “line detection information LD003”, and . . . } is stored as the “line detection information” on the line accepted by the plant administrator terminal 20 that is used by the plant administrator O identified by the “plant administrator PO001” in the line detection information storage unit 14f.

### 2-2-1-4. Detection Model Storage Unit 14d

The detection model storage unit 14d stores therein the detection model DM. Moreover, the detection model DM stored in the detection model storage unit 14d is the same as that described in the first embodiment; therefore, the description of the detection model DM will be omitted.

### 2-2-2. Control Unit 15

The control unit 15 manages the overall control of the server device 10-2. The control unit 15 includes the acquisition unit 15a, the acceptance unit 15b, the detection unit 15c, the providing unit 15d, and the notification unit 15e. Here, the control unit 15 may be implemented by, for example, an electronic circuit, such as a CPU or an MPU, or an integrated circuit, such as an ASIC or an FPGA.

### 2-2-2-1. Acquisition Unit 15a

The acquisition unit 15a performs the plant drawing information acquisition process. For example, the acquisition unit 15a acquires a plant drawing that is a configuration diagram that is generated by using a plurality of lines that indicate the plurality of respective connection elements that connect the components constituting the plant. At this time, the acquisition unit 15a acquires, as the plant drawing, the drawing data that includes the plurality of lines that have been generated by the digital data. Furthermore, the acquisition unit 15a acquires the plant drawing information that has been transmitted from the plant administrator terminal 20 corresponding to the user terminal and that is the drawing data on the plant drawing selected by the plant administrator O who is the user. Moreover, the acquisition unit 15a stores the acquired plant drawing information in the plant drawing information storage unit 14a.

Furthermore, the acquisition unit 15a performs a plant drawing information displaying process. For example, the acquisition unit 15a displays the acquired plant drawing that is used for construction, operation, and maintenance of the plant. At this time, the acquisition unit 15a causes the plant administrator terminal 20 to display the plant drawing.

As a specific example, the acquisition unit 15a acquires {“plant drawing PD001”, “plant drawing PD002”, “plant drawing PD003”, and . . . } as the plant drawing information acquired from the plant administrator terminal 20 that is used by the plant administrator O identified by the “plant administrator PO001”, stores the acquired plant drawing information in the plant drawing information storage unit 14a, and causes the plant administrator terminal 20 to display the plant drawing.

### 2-2-2-2. Acceptance Unit 15b

The acceptance unit 15b performs a line selection information acceptance process. For example, the acceptance unit 15b accepts the line selection information that indicates selection of a desired line from among the plurality of lines included in the displayed plant drawing. At this time, the acceptance unit 15b accepts, as the line selection information, the line that has been selected by an operation performed by the plant administrator O on the plant drawing that is displayed on the plant administrator terminal 20. Furthermore, the acceptance unit 15b may store the accepted line selection information in the storage unit 14-2.

Furthermore, the acceptance unit 15b may also accept, as a detection condition that is used at the time of detection of a line, the line angle information related to the orientation of the line, the line number information related to the line number that is attached to the line, the line shape information related to a thickness, a line type, a color, or the like of the line, or the like.

As a specific example, as a result of an arbitrary piping “P7017” included in the plant drawing that is displayed on the monitor screen of the plant administrator terminal 20 being selected by a click operation performed by the plant administrator O, the acceptance unit 15b accepts, as the line selection information received from the plant administrator terminal 20, “P7017-1” that is the identification information on the line associated with the selected piping “P7017”, “plant drawing PD001 (0, 1)” that is the positional information on the position in the plant drawing, and the like.

Furthermore, the acceptance unit 15b accepts, as the detection condition that is used at the time of detection of a line, {line angle information: “detect exact matched line”, line number information: “detect line including line number”, line shape information: “detect line with exact matched thickness”/“detect line with exact matched line type”/“ignore color differences”}, and the like.

### 2-2-2-3. Detection Unit 15c

The detection unit 15c performs a line pattern registration process, a line angle specifying process, a line number specifying process, a line detection process, a line detection information generating process, and the like.

### Line Pattern Registration Process

The detection unit 15c specifies, by using the digital data, at least one of the thickness, the line type, and the color of the line as the pattern of the accepted selection of the line. Furthermore, the detection unit 15c stores the specified line pattern in the line pattern information storage unit 14e.

As a specific example, in the case where “P7017-1” that is the identification information on the line associated with the selected piping “P7017”, and the “plant drawing PD001 (0, 1)” that is the positional information on the position in the plant drawing have been accepted, the detection unit 15c registers the line pattern by acquiring the plant drawing information on the “plant drawing PD001” from the plant drawing information storage unit 14a, specifying the digital data on the line associated with the control instrument “P7017” from the identification information and the positional information, specifying {thickness: “1.0 pt”, line type: “solid line”, color: “red”} as the pattern of the line associated with the piping “P7017”, and storing the specified data in the line pattern information storage unit 14e.

### Line Angle Specifying Process

The detection unit 15c specifies, by using the digital data, a line angle that is the orientation of the accepted selection of the line. Furthermore, the detection unit 15c may also store the specified line angle in the storage unit 14-2.

As a specific example, in the case where “P7017-1” that is the identification information on the line associated with the selected piping “P7017” and the “plant drawing PD001 (0, 1)” that is the positional information on the position in the plant drawing have been accepted, the detection unit 15c acquires the plant drawing information on the “plant drawing PD001” from the plant drawing information storage unit 14a, specifies the digital data on the line associated with the piping “P7017” from the identification information and the positional information, specifies {line angle: “180°” } as the line angle that is the orientation of the line associated with the piping “P7017”, and stores the obtained data in the storage unit 14-2.

### Line Number Specifying Process

The detection unit 15c specifies, by using the digital data, the line number that is attached to the accepted selection of the line. Furthermore, the detection unit 15c may also store the specified line number in the storage unit 14-2.

As a specific example, in the case where “P7017-1” that is the identification information on the line associated with the selected piping “P7017” and the “plant drawing PD001 (0, 1)” that is the positional information on the position in the plant drawing have been accepted, the detection unit 15c acquires the plant drawing information on the “plant drawing PD001” from the plant drawing information storage unit 14a, specifies the digital data on the line associated with the piping “P7017” from the identification information and the positional information, specifies {line number: “P7017 B1 H30”} as the line number that is attached to the line associated with the piping “P7017”, and stores the obtained data in the storage unit 14-2.

### Line Detection Process

The detection unit 15c detects a line from the plurality of lines that are included in the plant drawing on the basis of the pattern of the accepted selection of the line. For example, the detection unit 15c detects, from the displayed plant drawing, all of the lines having the shape that is matched with the registered pattern including the line that is used for the selection. Furthermore, the detection unit 15c detects all of the lines having the matched orientation from among the plurality of lines that are included in the plant drawing. Furthermore, the detection unit 15c detects all of the lines having the matched line number from among the plurality of lines that are included in the plant drawing.

As a specific example, in the case where {line shape information: “detect line with exact matched thickness”/“detect line with exact matched line type”/“ignore color differences”} has been accepted as the detection condition that is used at the time of detection of the line associated with the piping “P7017” included in the “plant drawing PD001”, the detection unit 15c acquires the plant drawing information on the “plant drawing PD001” from the plant drawing information storage unit 14a, acquires the line pattern {thickness: “1.0 pt”, line type: “solid line”, color: “red”} associated with the piping “P7017” from the line pattern information storage unit 14e, searches the plant drawing information on the “plant drawing PD001”, and detects the lines having the matched line pattern {thickness: “1.0 pt”, line type: “solid line”}.

Furthermore, in the case where {line angle information: “detect exact matched line”} has been accepted as the detection condition that is used at the time of detection of the line associated with the piping “P7017” included in the “plant drawing PD001”, the detection unit 15c further detects the line having the line angle of “180°” from among the lines having the line patterns that are matched or similar each other.

Furthermore, in the case where {line number information: “detect line including line number”} has been accepted as the detection condition that is used at the time of detection of the line associated with the piping “P7017” included in the “plant drawing PD001”, the detection unit 15c further detects the line having the line number of “P7017 B1 H30” from among the lines having the line patterns that are matched or similar each other.

### Line Detection Information Generating Process

The detection unit 15c generates the line detection information that is the detection result related to the detected lines. For example, the detection unit 15c generates, as the line detection information, the line detection drawing that is the configuration diagram in which the detected lines are highlighted. Furthermore, the detection unit 15c generates the line detection list that is a list of the detected lines. Furthermore, the detection unit 15c stores the generated line detection information in the line detection information storage unit 14f.

As a specific example of the line detection drawing, the detection unit 15c acquires the plant drawing information on the “plant drawing PD001” from the plant drawing information storage unit 14a, generates, as the line detection drawing, the plant drawing information on the “plant drawing PD001” that is highlighted by coloring the line associated with the detected piping “P7017” in blue, and stores the obtained data in the line detection information storage unit 14f.

As a specific example of the line detection list, the detection unit 15c generates the identification information {“P7017-1”, “P7017-2”, . . . , and “P7017-10”} on the detected piping “P7017” as the line detection list, and stores the obtained data in the line detection information storage unit 14f.

### 2-2-2-4. Providing Unit 15d

The providing unit 15d performs the line detection information transmission process. For example, the providing unit 15d provides the line detection information that is the detection result related to the line that has been detected by the detection unit 15c to plant administrator O by transmitting the line detection information to the plant administrator terminal 20.

As a specific example, the providing unit 15d transmits, as the line detection information, to the plant administrator terminal 20 that is used by the plant administrator O identified by the “plant administrator PO001”, the line detection drawing that is the plant drawing information on the “plant drawing PD001” that has been highlighted by coloring the line associated with the detected piping “P7017” in blue and the line detection list that is the identification information {“P7017-1”, “P7017-2”, . . . , and “P7017-10”} on the detected piping “P7017”.

### 2-2-2-5. Notification Unit 15e

The notification unit 15e performs the output result acquisition process, the detection mistake notification process, and the like.

### Output Result Acquisition Process

The notification unit 15e acquires an output result by using a trained machine learning model that outputs the line included in the plant drawing in accordance with an input of each of the digital data on the plant drawing and the line pattern.

As a specific example, the notification unit 15e inputs the plant drawing information on the “plant drawing PD001” and the line pattern {thickness: “1.0 pt”, line type: “solid line”} to the detection model DM included in the detection model storage unit 14d, and acquires {“P7017-1”, “P7017-2”, . . . , “P7017-10”, and “P7017-11”} that is an output result of the detection model DM.

### Detection Mistake Notification Process

The notification unit 15e notifies the plant administrator O of a detection omission or erroneous detection of the line obtained by using the output result of the trained machine learning model.

As a specific example, notification unit 15e compares the line detection list {“P7017-1”, “P7017-2”, . . . , and “P7017-10”} of the piping “P7017” that has been detected by the detection unit 15c with {“P7017-1”, “P7017-2”, . . . , “P7017-10”, and “P7017-11”} that is the output result of the detection model DM, determines a possibility of a detection omission of the line associated with the piping “P7017” that is the identification information “P7017-11”, generates a message indicating that “There is a possibility of a detection omission.”, or the like as the detection mistake information, and transmits the generated message to the plant administrator terminal 20 that is used by the plant administrator O that is identified by the “plant administrator PO001”.

### 2-3. Configuration Example and Process Example of Plant Administrator Terminal 20

A configuration example and a process example of the plant administrator terminal 20 will be described with reference to FIG. 12. The plant administrator terminal 20 is a terminal that is used by the plant administrator O who manages the plant, and includes the input/output unit 21, the control unit 22, and the communication unit 23.

### 2-3-1. Input/Output Unit 21

The input/output unit 21 manages an input of various kinds of information with respect to the plant administrator terminal 20. For example, the input/output unit 21 is implemented by a mouse, a keyboard, a touch panel, or the like, and receives an input of the setting information and the like with respect to the plant administrator terminal 20. Furthermore, the input/output unit 21 displays various kinds of information received from the plant administrator terminal 20. For example, the input/output unit 21 is implemented by a display or the like, and displays the setting information and the like that are stored in the plant administrator terminal 20.

The input/output unit 21 displays the plant drawing that is browsed by the plant administrator O. Furthermore, the plant drawing in detail will be described later in the section titled (2-3-4. Specific example 1 of display screen displayed on the plant administrator terminal 20). Furthermore, the input/output unit 21 displays a line selection screen by which the plant administrator O is able to select a symbol. Furthermore, the line selection screen in detail will be described later in the section titled (2-3-5. Specific example 2 of display screen displayed on the plant administrator terminal 20). Furthermore, the input/output unit 21 displays the line detection drawing that is browsed by the plant administrator O. Furthermore, the line detection drawing in detail will be described later in the section titled (2-3-6. Specific example 3 of display screen displayed on the plant administrator terminal 20).

### 2-3-2. Control Unit 22

The control unit 22 receives various kinds of information. For example, the control unit 22 transmits the plant drawing information on the plant drawing that has been selected by the plant administrator O to the server device 10-2. Furthermore, the control unit 22 transmits the line selection information on the line that has been selected by the plant administrator O on the line selection screen to the server device 10-2.

The control unit 22 receives various kinds of information. For example, the control unit 22 receives the line detection information including the line detection drawing, the line detection list, and the like that are displayed on the input/output unit 21 from the server device 10-2. Furthermore, the control unit 22 receives, from the server device 10-2, the detection mistake information that is displayed on the input/output unit 21, that indicates a detection omission or erroneous detection of a line, and that is notified to the plant administrator O.

### 2-3-3. Communication Unit 23

The communication unit 23 manages data communication performed with the other devices. For example, the communication unit 23 performs data communication with each of the communication devices via a router or the like. Furthermore, the communication unit 23 is able to perform data communication with a terminal that is used by an operator (not illustrated).

### 2-3-4. Specific Example 1 of Display Screen Displayed on Plant Administrator Terminal 20

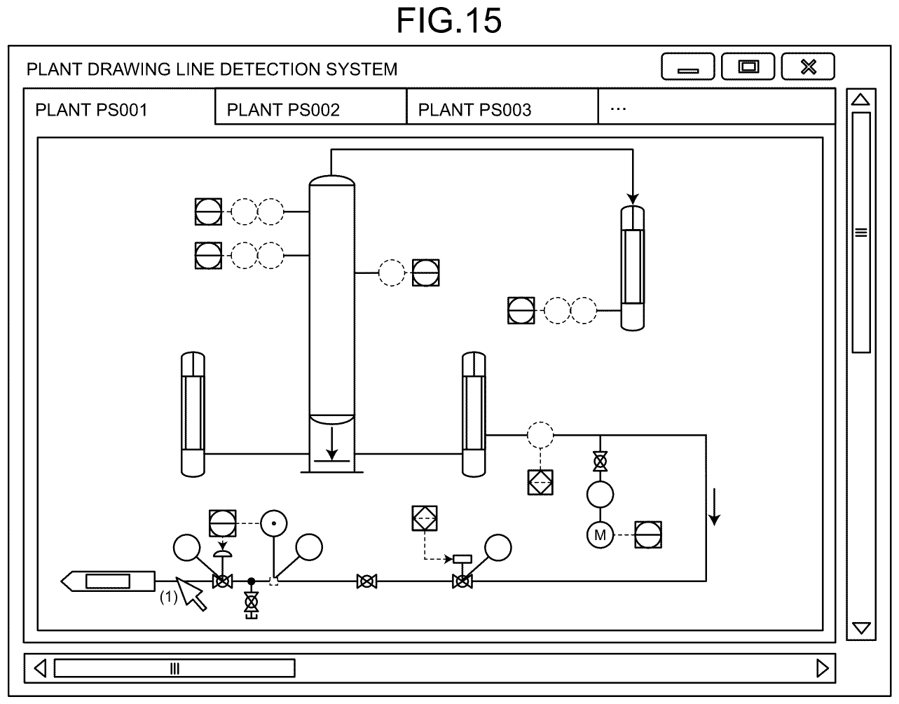

Here, a specific example 1 of a display screen that is output by the input/output unit 21 included in the plant administrator terminal 20 will be described with reference to FIG. 15. FIG. 15 is a diagram illustrating the specific example 1 of the display screen displayed on the plant administrator terminal 20 according to the second embodiment. In the following, a plant drawing that is browsed by the plant administrator O will be described.

### 2-3-4-1. Plant Drawing

As indicated by the example illustrated in FIG. 15, the plant administrator terminal 20 displays, for each plant, the plant drawing that has been generated by the symbols that indicate the respective components included in the plant and generated by the lines that indicate the respective connection elements and that connect the respective components included in the plant. In the example illustrated in FIG. 15, in the plant drawing indicated by the “plant PS001”, the lines associated with the piping that the plant administrator O desires to detect are displayed (see (1) in FIG. 15).

### 2-3-4-2. Display Format of Line

The plant administrator terminal 20 is able to display, as the lines, not only the lines each having a different shape, such as a thickness, a line type, a color, or the like, but also the lines each having a different orientation, the line each having a line number attached, and the like. At this time, the plant administrator terminal 20 is also able to display the plant drawing that indicates the configuration of a three-dimensional plant by depicting the relationship between before and after each of the lines.

### 2-3-5. Specific Example 2 of Display Screen Displayed on Plant Administrator Terminal 20

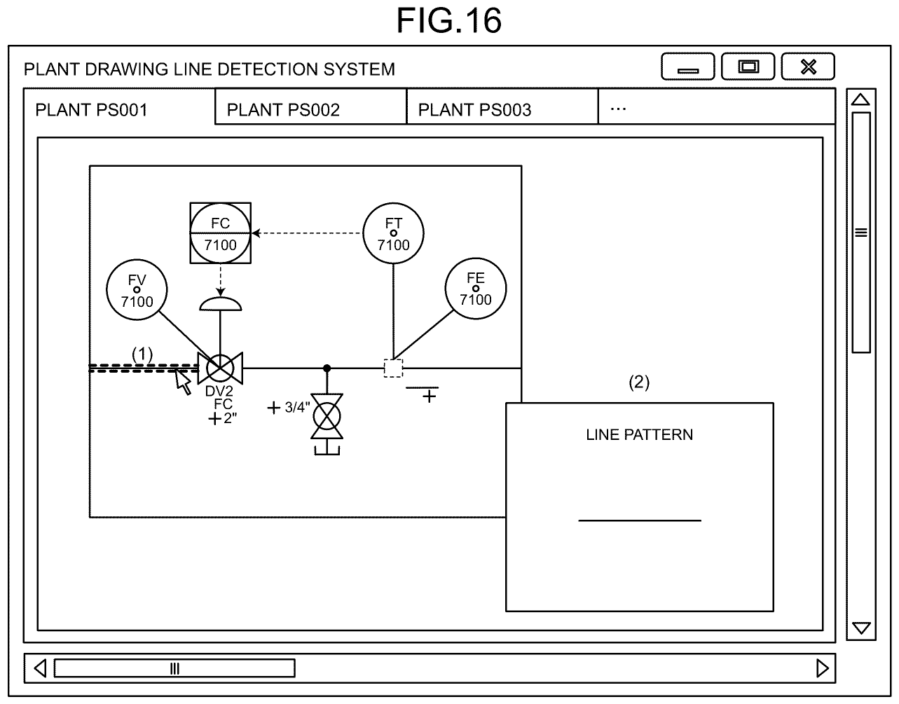

Here, a specific example 2 of the display screen that is output by the input/output unit 21 included in the plant administrator terminal 20 will be described with reference to FIG. 16. FIG. 16 is a diagram illustrating the specific example 2 of the display screen displayed on the plant administrator terminal 20 according to the second embodiment. In the following, the line selection screen by which the plant administrator O is able to select a line will be described.

### 2-3-5-1. Line Selection Screen

As indicated by the example illustrated in FIG. 16, the plant administrator terminal 20 displays the line selection screen that enables the plant administrator O to select, on the plant drawing, the line that the plant administrator O desires to select. In the example illustrated in FIG. 16, in the plant drawing indicated by the “plant PS001”, the plant administrator terminal 20 displays the plant drawing in which an area around the line (see (1) in FIG. 16) indicating the piping that the plant administrator O desires to detect has been enlarged. At this time, the plant administrator O is able to select the target line by performing a click operation on the line that the plant administrator O desires to detect.

Furthermore, the plant administrator terminal 20 displays the line pattern (see (2) in FIG. 16) in which the line selected by the plant administrator O has been enlarged on the plant drawing. At this time, the plant administrator O is also able to correct the diagram of the displayed line pattern, or also able to delete the line number attached to the line.

### 2-3-5-2. Assignment of Detection Condition

The plant administrator O is able to assign a detection condition that is used at the time of detection of the line. For example, the plant administrator O is able to assign, as the detection condition, a matched condition of one of the thicknesses, the line types, and the colors that correspond to the line patterns, the orientation of each of the lines, presence or absence of a line number attached to a line, or the like. In addition, the plant administrator O is also able to assign the detection condition for detecting the length of the lines is fully matched.

### 2-3-6. Specific Example 3 of Display Screen Displayed on Plant Administrator Terminal 20

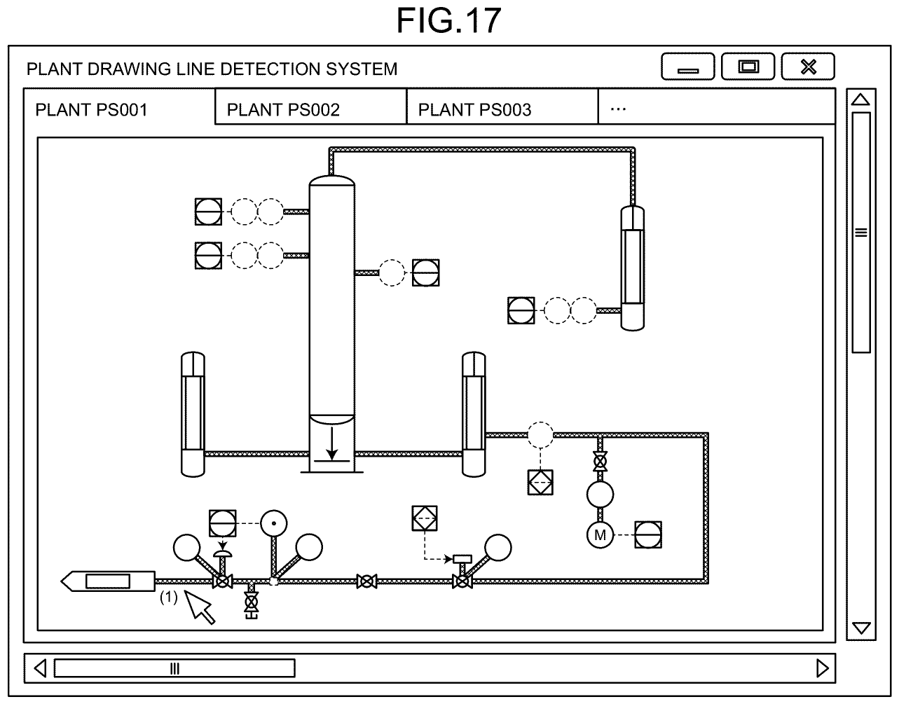

Here, a specific example 3 of the display screen that is output by the input/output unit 21 included in the plant administrator terminal 20 will be described with reference to FIG. 17. FIG. 17 is a diagram illustrating the specific example 3 of the display screen displayed on the plant administrator terminal 20 according to the second embodiment. In the following, the line detection drawing that is browsed by the plant administrator O will be described.

### 2-3-6-1. Line Detection Drawing

As indicated by the example illustrated in FIG. 17, the plant administrator terminal 20 displays the plant detection drawing that is highlighted by coloring the detected line. In the example illustrated in FIG. 17, the plant administrator terminal 20 displays the line detection drawing that is the plant drawing in which the lines of the detected piping are highlighted in blue in the plant drawing indicated by the “plant PS001” (see grid line portions in FIG. 17). At this time, the plant administrator terminal 20 highlights all of the lines associated with the piping including the line (see (1) in FIG. 17) associated with the piping that has been selected by the plant administrator O.

### 2-3-6-2. Line Detection List

The plant administrator terminal 20 is also able to display the line detection list that is a list of the detected lines. For example, the plant administrator terminal 20 is also able to display, as the line detection list, the list of the lines including the identification information on the detected piping and the positional information on the detected lines.

### 2-3-6-3. Notification of Detection Mistake

The plant administrator terminal 20 is also able to display a detection mistake notification that indicates a possibility of a detection omission or erroneous detection of the line. For example, the plant administrator terminal 20 is also able to display a message indicating that “There is a possibility of a detection omission.”, or the like as the detection mistake notification.

### 3. Flow of Process Performed in Information Providing System 100-2

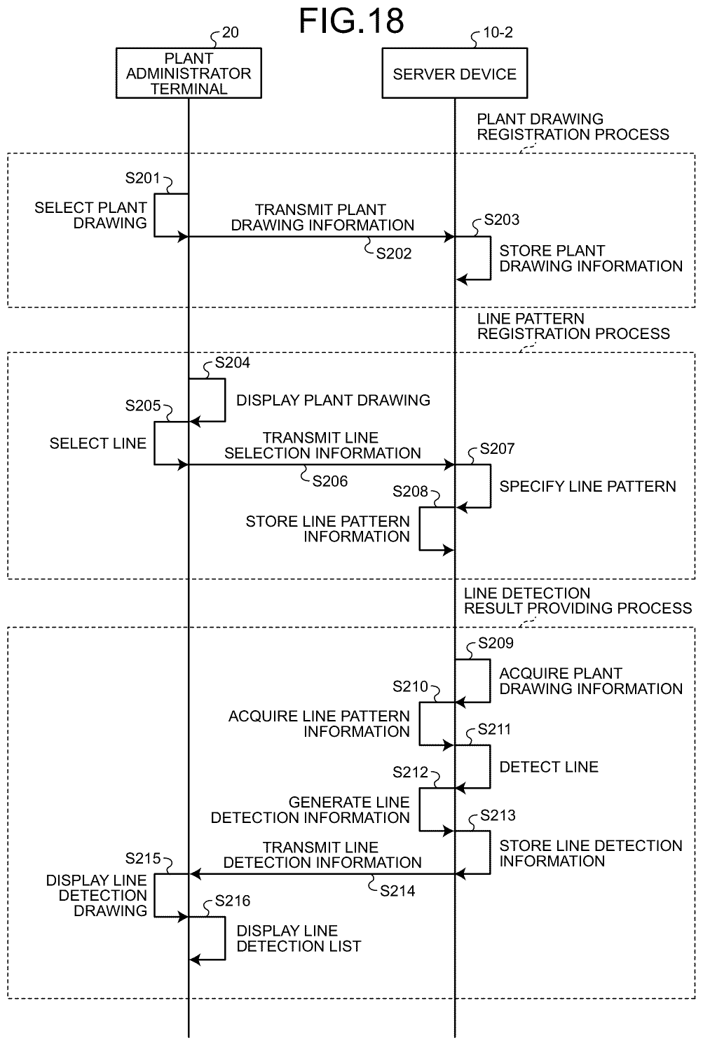

The flow of the process performed in the information providing system 100-2 according to the second embodiment will be described with reference to FIG. 18. FIG. 18 is a sequence diagram illustrating one example of the flow of the process performed in the information providing system 100-2 according to the second embodiment. In the following, explanations will be given in the order of the plant drawing registration process, the line pattern registration process, and the line detection result providing process. Furthermore, the processes at Steps S201 to S216 may also be performed in different order. Moreover, from among the processes at Steps S201 to S216 described below, there may be a process that is omitted.

### 3-1. Plant Drawing Registration Process

The information providing system 100-2 performs the plant drawing registration process that is indicated by the processes at Steps S201 to S203 described below.

At a first step, the plant administrator terminal 20 performs the plant drawing selection process (Step S201). For example, the plant administrator terminal 20 accepts the plant drawing of the plant that has been selected by the operation performed by the plant administrator O. At a second step, the plant administrator terminal 20 performs the plant drawing information transmission process (Step S202). For example, the plant administrator terminal 20 transmits, to the server device 10-2, the digital data on the plant drawing of the plant that has been selected by the operation performed by the plant administrator O. At a third step, the server device 10-2 performs the plant drawing information storing process (Step S203). For example, the server device 10-2 stores the plant drawing information received from the plant administrator terminal 20 for each of the plant administrators O.

### 3-2. Line Pattern Registration Process

The information providing system 100-2 performs the line pattern registration process that is indicated by the processes at Steps S204 to S208 described below.

At a first step, the plant administrator terminal 20 performs the plant drawing displaying process (Step S204). For example, the plant administrator terminal 20 displays, on the monitor screen, the plant drawing of the plant that has been selected by an operation performed by the plant administrator O. At a second step, the plant administrator terminal 20 performs the line selection process (Step S205). For example, the plant administrator terminal 20 accepts the line that has been selected by the operation performed by the plant administrator O on the plant drawing. At a third step, the plant administrator terminal 20 performs the line selection information transmission process (Step S206). For example, the plant administrator terminal 20 transmits, to the server device 10-2, the identification information on the line that has been selected by the operation performed by the plant administrator O and the positional information on the position of the line indicated in the plant drawing. At a fourth step, the server device 10-2 performs the line pattern specifying process (Step S207). For example, the server device 10-2 refers to the plant drawing information on the basis of the line selection information received from the plant administrator terminal 20, and specifies the line pattern from the digital data on the plant drawing information. At a fifth step, the server device 10-2 performs the line pattern information storing process (Step S208). For example, the server device 10-2 stores the line pattern information including the specified line pattern for each of the plant administrators O.

### 3-3. Line Detection Result Providing Process

The information providing system 100-2 performs the line detection result providing process that is indicated by the processes at Steps S209 to S216 described below.

At a first step, the server device 10-2 performs the plant drawing information acquisition process (Step S209). For example, the server device 10-2 accepts a request for detecting a line made by an operation performed by the plant administrator O, searches the stored plant drawing information, and acquires the plant drawing information on the corresponding plant. At a second step, the server device 10-2 performs the line pattern information acquisition process (Step S210). For example, the server device 10-2 accepts a request for detecting a line made by an operation performed by the plant administrator O, searches the stored line pattern information, and acquires the line pattern information on the corresponding line. At a third step, the server device 10-2 performs the line detection process (Step S211). For example, the server device 10-2 searches the acquired plant drawing information, and detects the line having the line pattern that is matched with the acquired line pattern information. At a fourth step, the server device 10-2 performs the line detection information generating process (Step S212). For example, the server device 10-2 generates the line detection drawing in which the detected lines are highlighted, and the line detection list that indicates a list of the detected lines. At a fifth step, the server device 10-2 performs the line detection information storing process (Step S213). For example, the server device 10-2 stores, for each of the plant administrator O, the line detection information that includes the generated line detection drawing and the line detection list. At a sixth step, the server device 10-2 performs the line detection information transmission process (Step S214). For example, the server device 10-2 transmits, to the plant administrator terminal 20, the line detection information that includes the generated line detection drawing and the line detection list. At a seventh step, the plant administrator terminal 20 performs the line detection drawing displaying process (Step S215). For example, the plant administrator terminal 20 displays the line detection drawing that is included in the line detection information received from the server device 10-2 on the monitor screen. At an eighth step, the plant administrator terminal 20 performs the line detection list displaying process (Step S216). For example, the plant administrator terminal 20 displays the line detection list that is included in the line detection information received from the server device 10-2 on the monitor screen.

### 4. Effect of Second Embodiment

Lastly, the effect of the second embodiment will be described. In the following, effects 1 to 5 associated with the processes according to the second embodiment will be described.

### 4-1. Effect 1

At a first step, in the above described processes according to the second embodiment, the server device 10-2 receives the plant drawing that has been generated by using each of the lines that indicate the plurality of respective connection elements that connect the components constituting the plant, accepts, from the plant administrator terminal 20, selection of an arbitrary connection element from among the plurality of connection elements, detects a line from among the lines that are included in the plant drawing on the basis of the line pattern of the line that indicates the selected connection element, and transmits the line detection information related to the detected line to the plant administrator terminal 20. As a result of this, in the processes according to the second embodiment, it is possible to efficiently provide the information related to the lines that are included in the plant drawing.

### 4-2. Effect 2

At a second step, in the above described processes according to the second embodiment, the server device 10-2 receives, as the plant drawing, the drawing data that includes each of the lines generated by the digital data, accepts an arbitrary connection element that has been selected by an operation performed by the plant administrator O on the plant drawing that is displayed on the plant administrator terminal 20, specifies, as the pattern of the line selected by using the digital data, at least one of the thickness, the line type, and the color of the line, and detects the lines each having a matched pattern or a similar pattern from among the lines that are included in the plant drawing. As a result of this, in the processes according to the second embodiment, it is possible to efficiently provide the information related to the lines that are included in the plant drawing by detecting the lines each having a shape that is matched with or similar to the shape of the line that has been selected by the plant administrator O.

### 4-3. Effect 3

At a third step, in the above described processes according to the second embodiment, the server device 10-2 specifies the orientation of the selected line, and detects the line each having the matched orientation from among the lines that are included in the plant drawing. As a result of this, in the processes according to the second embodiment, it is possible to efficiently provide the information related to the lines that are included in the plant drawing by detecting the lines each having the shape that is matched with or similar to the shape of the line that has been selected by the plant administrator O, and also having the orientation that is matched with the orientation of the line that has been selected by the plant administrator O.

### 4-4. Effect 4

At a fourth step, in the above described processes according to the second embodiment, the server device 10-2 further specifies the line number that is attached to the selected line, and detects the line having the matched line number from among the lines that are included in the plant drawing. As a result of this, in the processes according to the second embodiment, it is possible to efficiently provide the information related to the lines that are included in the plant drawing by detecting the lines each having a shape that is matched with or similar to the shape of the line that has been selected by the plant administrator O, and also, by detecting the lines each having the line number that is matched with the line number attached to the line selected by the plant administrator O.

### 4-5. Effect 5

At a fifth step, in the above described processes according to the second embodiment, the server device 10-2 generates, as the line detection information, at least one of the plant drawing, in which the detected line is highlighted, and the list of the detected lines. As a result of this, in the processes according to the second embodiment, it is possible to efficiently provide the line detection drawing and the line detection list as the information related to the lines that are included in the plant drawing.

### Third Embodiment

In the following, a configuration and a process related to an information providing system 100-3 that is a plant drawing symbol detection system and a plant drawing line detection system according to a third embodiment, a configuration and a process related to each of the devices included in the information providing system 100-3, and the flow of the processes performed in the information providing system 100-3 will be described in this order and, at the end, effects of the third embodiment will be described. Furthermore, descriptions of the configuration and the processes that are the same as those described in the first embodiment or the second embodiment will be omitted.

### 1. Configuration and Process Related Information Providing System 100-3

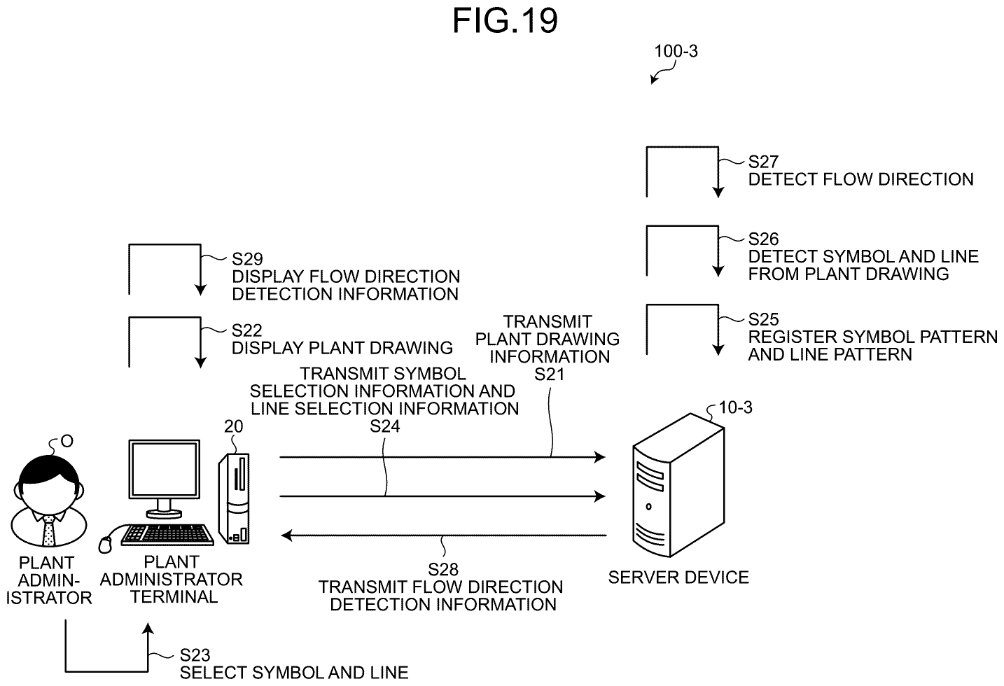

A configuration and a process related to an information providing system 100-3 according to the third embodiment will be described with reference to FIG. 19. FIG. 19 is a diagram illustrating a configuration example and a process example of the information providing system 100-3 according to the third embodiment. In a description below, the configuration example of the entire information providing system 100-3, the process example of the information providing system 100-3, and the effects of the information providing system 100-3 will be described.

### 1-1. Configuration Example of Entire Information Providing System 100-3

The configuration example of the entire information providing system 100-3 according to the third embodiment will be described. The information providing system 100-3 includes a server device 10-3 that is an information providing device (plant symbol line detection device, and plant drawing line detection device), and the plant administrator terminal 20 that is used by the plant administrator O. Here, the server device 10-3 and the plant administrator terminal 20 are connected via a predetermined communication network (network) (not illustrated) so as to be able to communicate each other in a wired or wireless manner. Furthermore, for the predetermined communication network, it is possible to use various communication networks including the Internet, a dedicated line, or the like. Moreover, in the information providing system 100-3 illustrated in FIG. 19, two or more of the server devices 10-3 or two or more of the plant administrator terminals 20 may be included.

### 1-2. Process Example of Entire Information Providing System 100-3

A process example of the entire information providing system 100-3 according to the third embodiment will be described. Furthermore, the processes performed at Steps S21 to S29 may also be in different order. Moreover, from among the processes performed at Steps S21 to S29 described below, there may be a process that is omitted.

### 1-2-1. Plant Drawing Information Transmission Process

At a first step, the plant administrator terminal 20 transmits the plant drawing information to the server device 10-3 (Step S21). For example, the plant administrator terminal 20 transmits the plant drawing information that has been selected by an operation performed by the plant administrator O to the server device 10-3. At this time, the server device 10-3 receives the plant drawing information and stores the received plant drawing information.

### 1-2-2. Plant Drawing Displaying Process

At a second step, the plant administrator terminal 20 displays the plant drawing (Step S22). For example, the plant administrator terminal 20 displays the plant drawing that has been selected by the operation performed by the plant administrator O on the monitor screen.

### 1-2-3. Symbol and Line Selection Process

At a third step, the plant administrator O selects a symbol and a line by operating the plant administrator terminal 20 (Step S23). For example, the plant administrator O selects the symbol associated with the control device by performing a click operation on the symbol associated with the control device included in the plant drawing that is displayed on the monitor screen of the plant administrator terminal 20, and selects the line associated with the piping by performing a click operation on the line associated with the piping included in the plant drawing that is displayed on the monitor screen of the plant administrator terminal 20.

### 1-2-4. Symbol Selection Information and Line Selection Information Transmission Process

At a fourth step, the plant administrator terminal 20 transmits the symbol selection information and the line selection information to the server device 10-3 (Step S24). For example, the plant administrator terminal 20 transmits identification information on the symbol associated with the control device that has been selected by the plant administrator O and the positional information on the position of the symbol in the plant drawing to the server device 10-3, and transmits the identification information on the line associated with the piping that has been selected by the plant administrator O and the positional information on the position of the line in the plant drawing to the server device 10-3.

### 1-2-5. Symbol Pattern and Line Pattern Registration Process

At a fifth step, the server device 10-3 registers a symbol pattern and a line pattern (Step S25). For example, the server device 10-3 acquires plant drawing information on the basis of the symbol selection information received from the plant administrator terminal 20, and specifies a symbol pattern from the digital data on the symbol associated with the corresponding control device. At this time, the server device 10-3 stores the specified symbol pattern as the symbol pattern information. Furthermore, the server device 10-3 acquires the plant drawing information on the basis of the line selection information received from the plant administrator terminal 20, and specifies a line pattern from the digital data on the line associated with the corresponding piping. At this time, the server device 10-3 stores the line associated with the specified line pattern as the pattern information.

### 1-2-6. Symbol and Line Detection Process

At a sixth step, the server device 10-3 detects the symbol and the line from the plant drawing (Step S26). For example, the server device 10-3 searches the acquired plant drawing information, and detects the symbol having the symbol pattern that is matched with or similar to the specified symbol pattern. At this time, the server device 10-3 generates the symbol detection information that includes the symbol detection drawing that is highlighted plant drawing obtained by coloring the detected symbol, and stores the generated symbol detection information. Furthermore, the server device 10-3 generates symbol detection information that includes a symbol detection list that indicates a list of the detected symbols, and stores the generated symbol detection information.

Furthermore, the server device 10-3 searches the acquired plant drawing information, and detects the line having the line pattern that is matched with or similar to the specified line pattern. At this time, the server device 10-3 generates the line detection information that includes the line detection drawing that is a highlighted plant drawing obtained by coloring the detected line, and stores the generated line detection information. Furthermore, the server device 10-3 generates the line detection information that includes a line detection list that includes a list of the detected lines, and stores the generated line detection information.

### 1-2-7. Flow Direction Detection Process

At a seventh step, the server device 10-3 detects a flow direction from the plant drawing (Step S27). For example, the server device 10-3 searches the acquired plant drawing information, and detects a flow direction that indicates the flow of a fluid, a signal, or the like on the basis of the detected symbol, the detected line, and a sign that indicates the flow direction. At this time, the server device 10-3 generates flow direction detection information that includes a flow direction detection drawing that is a plant drawing in which a curve with an arrow that indicates the detected flow direction is displayed in a superimposed manner, and stores the generated flow direction detection information. Furthermore, the server device 10-3 generates the flow direction detection information that includes a flow direction detection list that indicates a list of the detected flow directions.

The server device 10-3 detects the flow direction by using the detection model DM that is the machine learning model, and, in the case where a detection mistake, such as a detection omission or erroneous detection, has been made in the flow direction detection information, the server device 10-3 may notify the plant administrator O of the detection mistake.

### 1-2-8. Flow Direction Detection Information Transmission Process

At an eighth step, the server device 10-3 transmits the flow direction detection information to the plant administrator terminal 20 (Step S28). For example, the server device 10-3 transmits the flow direction detection information that includes the flow direction detection drawing and the flow direction detection list to the plant administrator terminal 20.

### 1-2-9. Flow Direction Detection Information Displaying Process

At a ninth step, the plant administrator terminal 20 displays the flow direction detection information (Step S29). For example, the plant administrator terminal 20 displays the flow direction detection drawing that is included in the received flow direction detection information on the monitor screen. Furthermore, the plant administrator terminal 20 may also display the flow direction detection list that is included in the received flow direction detection information on the monitor screen.

### 1-3. Overall Effect of Information Providing System 100-3

In the following, a point at issue of a reference technology will be described, and then, the effect of the information providing system 100-3 will be described.

### 1-3-1. Point at Issue of Reference Technology

In the technologies of the reference technology 1 and the reference technology 2 described above in the first embodiment, there is a problem in that it is difficult to register the pattern of the desired symbol and line from among the plurality of symbols and the lines that are present in the plant drawing that is used for construction, operation, and maintenance of the plant, detect all of the symbols and the lines each having a shape or the like that is matched with the shape or the like of the registered pattern from the plant drawing, and provide the detected symbols and lines. Furthermore, there is also a known detection technology for detecting a symbol and a line from a plant drawing, such as a P&ID, generated by the two-dimensional CAD by using a machine learning model, but there is a problem in that detection accuracy is low. Furthermore, in the technologies of the reference technology 1 and the reference technology 2, there is a problem in that it is difficult to detect, after having detected a symbol and a line from the plant drawing, a flow direction of the fluid and the signal flowing through the detected symbol and the detected line and provide the detected flow direction.

### 1-3-2. Outline of Information Providing System 100-3

The information providing system 100-3 includes the server device 10-3 that is the information providing device and the plant administrator terminal 20 that is used by the plant administrator O. Similar to the process performed in the server device 10-1 as described above in the first embodiment, the server device 10-3 detects, on the basis of the symbol pattern of the symbol that indicates the selected component, the symbol having the symbol pattern that is matched with or similar to the symbol pattern of each of the symbols that are included in the plant drawing. Furthermore, similar to the process performed in the server device 10-2 as described above in the second embodiment, the server device 10-3 detects, on the basis of the line pattern of the line that indicates the selected connection element, from each of the lines included in the plant drawing, the lines each having a matched or a similar line pattern included in the plant drawing. Then, the server device 10-3 detects a flow direction by using the detected symbol, the detected line, and the sign that indicates the flow direction that is included in the plant drawing. At this time, the server device 10-3 transmits the flow direction detection drawing that is the plant drawing in which a curve with an arrow that indicates the detected flow direction is displayed in a superimposed manner and the flow direction detection list that indicates a list of the detected flow directions as the flow direction detection information, and displays the flow direction detection information on the monitor screen of the plant administrator terminal 20.

### 1-3-3. Effect

The information providing system 100-3 is able to efficiently detect the flow direction from the plant drawing that is used for construction, operation, and maintenance of the plant, and provide the detected flow direction to the plant administrator O, a plant engineer, a plant construction business person, or the like who is a user of the plant drawing. Furthermore, in the information providing system 100-3, it is possible to implement pattern extraction with further high accuracy as compared to a symbol detection technology, a line detection technology, and the like that use only the machine learning model.

As described above, in the information providing system 100-3, it is possible to efficiently provide the information related to the flow direction from the drawing that is related to the plant, so that it is possible to expect to contribute to a development of the plant related technology whose market is expanding.

### 2. Configuration of Each Device in Information Providing System 100-3 and Process Performed by Each Device

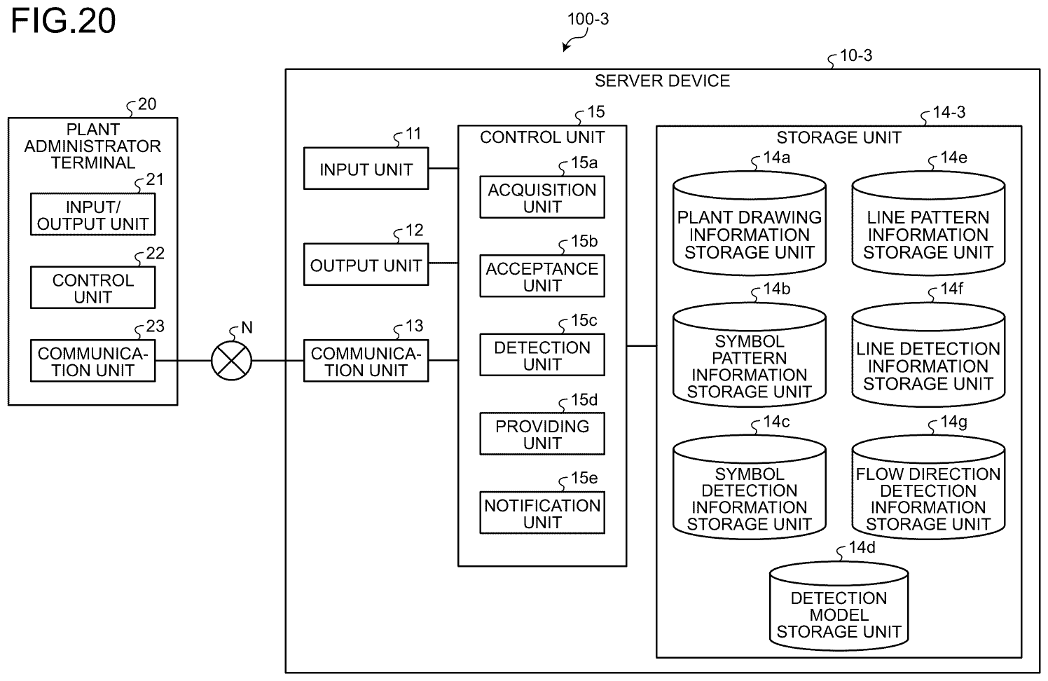

A configuration example and a process example of each of the devices included in the information providing system 100-3 illustrated in FIG. 19 will be described with reference to FIG. 20 to FIG. 24. In a description below, a configuration example of the entire information providing system 100-3 will be described, and then, both a configuration example and a process example of the server device 10-3 will be descried, and both a configuration example and a process example of the plant administrator terminal 20 will be described in detail.

### 2-1. Configuration Example of Entire Information Providing System 100-3

The configuration example of the entire information providing system 100-3 illustrated in FIG. 19 will be described with reference to FIG. 20. FIG. 20 is a block diagram illustrating the configuration example of each of the devices included in the information providing system 100-3 according to the third embodiment. As illustrated in FIG. 20, the information providing system 100-3 includes the server device 10-3 that is the information providing device and the plant administrator terminal 20 that is the user terminal. The server device 10-3 is connected to the plant administrator terminal 20 by the communication network N that is implemented by the Internet, a dedicated line, or the like, so as to be able to communicate each other. Furthermore, the server device 10-3 is installed in a cloud environment, an on-premise environment, an edge environment, or the like.

### 2-2. Configuration Example and Process Example of Server Device 10-3

A configuration example and a process example of the server device 10-3 illustrated in FIG. 19 will be described with reference to FIG. 20. The server device 10-3 includes the input unit 11, the output unit 12, the communication unit 13, a storage unit 14-3, and the control unit 15. In the following, the configuration example and the process example of the server device 10-3 will be described, and, in addition, the plant administrator terminal 20 is also able to perform the same process at the performed by the server device 10-3. In other words, the information providing system 100-3 is also able to be implemented by only the plant administrator terminal 20. Furthermore, the configuration example and the process example of each of the input unit 11, the output unit 12, and the communication unit 13 are the same as those described in the first embodiment; therefore, descriptions thereof will be omitted.

### 2-2-1. Storage Unit 14-3

The storage unit 14-3 stores therein various kinds of information that is referred when the control unit 15 is operated, and various kinds of information that have been acquired when the control unit 15 is operated. The storage unit 14-3 includes the plant drawing information storage unit 14a, the symbol pattern information storage unit 14b, the symbol detection information storage unit 14c, the line pattern information storage unit 14e, the line detection information storage unit 14f, a flow direction detection information storage unit 14g, and the detection model storage unit 14d. Here, the storage unit 14-3 may be implemented by, for example, a semiconductor memory device, such as a RAM or a flash memory, or a storage device, such as a hard disk or an optical disk. Furthermore, in the example illustrated in FIG. 20, the storage unit 14-3 is installed in the server device 10-3; however, the storage unit 14-3 may be installed outside the server device 10-3, or a plurality of storage units may be installed.

### 2-2-1-1. Plant Drawing Information Storage Unit 14a

The plant drawing information storage unit 14a stores therein the plant drawing information. Moreover, the plant drawing information stored in the plant drawing information storage unit 14a is the same as that described in the first embodiment; therefore, the description of the plant drawing information will be omitted.

### 2-2-1-2. Symbol Pattern Information Storage Unit 14b

The symbol pattern information storage unit 14b stores therein the symbol pattern information. Moreover, the symbol pattern information stored in the symbol pattern information storage unit 14b is the same as that described in the first embodiment; therefore, the description of the plant drawing information will be omitted.

### 2-2-1-3. Symbol Detection Information Storage Unit 14c

The symbol detection information storage unit 14c stores therein the symbol detection information. Moreover, the symbol detection information stored in the symbol detection information storage unit 14c is the same as that described in the first embodiment; therefore, the description of the plant drawing information will be omitted.

### 2-2-1-4. Line Pattern Information Storage Unit 14e

The line pattern information storage unit 14e stores therein the line pattern information. Moreover, the line pattern information stored in the line pattern information storage unit 14e is the same as that described in the first embodiment; therefore, the description of the plant drawing information will be omitted.

### 2-2-1-5. Line Detection Information Storage Unit 14f

The line detection information storage unit 14f stores therein the line detection information. Moreover, the line detection information stored in the line detection information storage unit 14f is the same as that described in the first embodiment; therefore, the description of the plant drawing information will be omitted.

### 2-2-1-6. Flow Direction Detection Information Storage Unit 14g

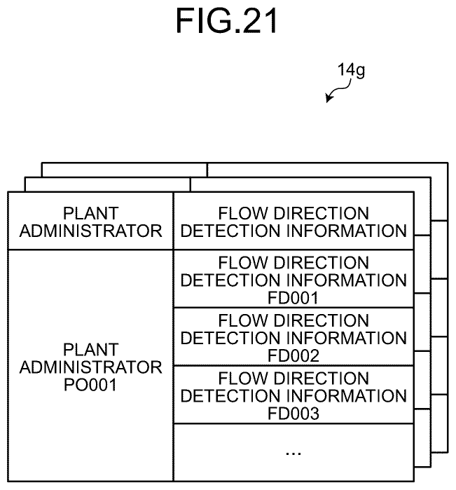

The flow direction detection information storage unit 14g stores therein the flow direction detection information. For example, the flow direction detection information storage unit 14g stores therein the flow direction detection information that is generated by the detection unit 15c that will be described later and that is included in the control unit 15. In the following, one example of the data stored in the flow direction detection information storage unit 14g will be described with reference to FIG. 21. FIG. 21 is a diagram illustrating one example of the flow direction detection information storage unit 14g included in the server device 10-3 according to the third embodiment. In the example illustrated in FIG. 21, the flow direction detection information storage unit 14g includes items, such as the “plant administrator” and the “flow direction detection information”.

The “plant administrator” indicates the identification information for identifying a user who uses the plant drawing, and is, for example, an identification number or an identification sign assigned to the plant administrator O. The “flow direction detection information” is the information that is related to the flow direction that has been detected by the detection unit 15c, and is, for example, the flow direction detection drawing that is the plant drawing in which a curve with an arrow that indicates the detected flow direction is displayed in a superimposed manner, the flow direction detection list that indicates a list of the detected flow directions, and the like.

In other words, FIG. 5 illustrates an example in which, data corresponding to {“flow direction detection information FD001”, “flow direction detection information FD002”, “flow direction detection information FD003”, and . . . } is stored in the symbol detection information storage unit 14f as the “flow direction detection information” that is involved by the symbol and the line accepted by the plant administrator terminal 20 that is used by the plant administrator O identified by the “plant administrator PO001”.

### 2-2-1-7. Detection Model Storage Unit 14d

The detection model storage unit 14d stores therein the detection model DM. Moreover, the detection model DM stored in the detection model storage unit 14d is the same as that described in the first embodiment; therefore, the description of the plant drawing information will be omitted.

### 2-2-2. Control Unit 15

The control unit 15 manages the overall control of the server device 10-3. The control unit 15 includes the acquisition unit 15a, the acceptance unit 15b, the detection unit 15c, the providing unit 15d, and the notification unit 15e. Here, the control unit 15 may be implemented by, for example, an electronic circuit, such as a CPU or an MPU, or an integrated circuit, such as an ASIC or an FPGA.

### 2-2-2-1. Acquisition Unit 15a

The acquisition unit 15a performs a plant drawing information reception process. Moreover, the plant drawing information reception process performed by the acquisition unit 15a is the same as that described in the first embodiment and the second embodiment; therefore, the description of the plant drawing information will be omitted.

### 2-2-2-2. Acceptance Unit 15b

The acceptance unit 15b performs the symbol selection information acceptance process, the line selection information acceptance process, and the like. Moreover, the symbol selection information acceptance process performed by the acceptance unit 15b is the same as that described in the first embodiment; therefore, the description of the plant drawing information will be omitted. Furthermore, the line selection information acceptance process performed by the acceptance unit 15b is the same as that described in the second embodiment; therefore, the description of the plant drawing information will be omitted.

### 2-2-2-3. Detection Unit 15c

The detection unit 15c performs the symbol pattern registration process, the symbol angle specifying process, the symbol text specifying process, the symbol detection process, the symbol detection information generating process, the line pattern registration process, the line angle specifying process, the line number specifying process, the line detection process, the line detection information generating process, the flow direction detection process, the flow direction detection information generating process, and the like. Moreover, the symbol pattern registration process, the symbol angle specifying process, the symbol text specifying process, the symbol detection process, and the symbol detection information generating process performed by the detection unit 15c are the same as those described in the first embodiment; therefore, the descriptions thereof will be omitted. Furthermore, the line pattern registration process, the line angle specifying process, the line number specifying process, the line detection process, and the line detection information generating process performed by the detection unit 15c are the same as those described in the second embodiment; therefore, the descriptions thereof will be omitted.

### Flow Direction Detection Process

The detection unit 15c detects the flow direction of the fluid or the signal included in the plant drawing that is the configuration diagram generated by using the plurality of symbols that indicate the plurality of respective components that constitute the plant and using the plurality of lines that indicate the plurality of respective connection elements that connect the components that constitute the plant. For example, the detection unit 15c detects all of the symbols having the symbol patterns that are matched each other from the plurality of symbols that are included in the plant drawing, detects all of the lines having the line patterns that are matched each other from among the plurality of lines that are included in the plant drawing, and detects a flow direction by using the detected symbols, detected lines, and the signs that indicate the respective direction sand that are included in the plant drawing.

As a specific example, the detection unit 15c detects the control instrument “FC7100” included in the “plant drawing PD001”, and, if the detection unit 15c detects the line associated with the piping “P7017” included in the “plant drawing PD001”, the detection unit 15c specifies the connection relation from the positional information on the position of each of the control instrument “FC7100” and the piping “P7017” included in the “plant drawing PD001”, and detects the fluid that is associated with the specified connection relation, or detects the flow direction of the signal. At this time, in the case where the detection unit 15c is able to specify the flow direction from the specified connection relation, the detection unit 15c detects the specified flow direction. Furthermore, in the case where the detection unit 15c is not able to specify the flow direction from the specified connection relation, the detection unit 15c detects a flow direction in accordance with the sign that indicates the flow direction, such as the arrow illustrated in the plant drawing or arrow feather diagram.

### Flow Direction Detection Information Generating Process

The detection unit 15c generates the flow direction detection information that is the detection result related to the detected flow direction. For example, the detection unit 15c connects the detected symbol and the detected line as the flow direction detection information, and generates a flow direction detection drawing that is the configuration diagram in which the curve with the arrow that indicates the flow direction is displayed by being superimposed on the symbol and the line. Furthermore, the detection unit 15c generates, as the flow direction detection information, a flow direction detection list that is a list of the detected symbols, the detected lines, and the flow direction. Furthermore, the detection unit 15c stores the generated flow direction detection information in the flow direction detection information storage unit 14g.

As a specific example of the flow direction detection drawing, the detection unit 15c acquires the plant drawing information on the “plant drawing PD001” from the plant drawing information storage unit 14a, highlights the symbol associated with the detected control instrument “FC7100” and the line associated with the detected piping “P7017” by coloring the symbol and the line in blue, and, furthermore, generates, as the flow direction detection drawing, the plant drawing information on the “plant drawing PD001” in which the curve with the blue arrow that indicates the flow direction of the fluid or the signal flowing through the symbol associated with the control instrument “FC7100” and the line associated with the piping “P7017” are superimposed on the symbol and the line, and stores the generated flow direction detection drawing in the flow direction detection information storage unit 14g.

As a specific example of the line detection list, the detection unit 15c generates {“FC7100-6” →“P7017-2” →“FC7100-6”, and . . . } as the flow direction detection list corresponding to the list of the connection relation between the symbol associated with the control instrument “FC7100” and the line associated with the piping “P7017” and the list of the flow directions of the fluids or the signals, and stores the generated flow direction detection list in the flow direction detection information storage unit 14g.

### 2-2-2-4. Providing Unit 15d

The providing unit 15d performs the flow direction detection information transmission process. For example, the providing unit 15d transmits the flow direction detection information that is the detection result related to the flow direction that has been detected by the detection unit 15c to the plant administrator terminal 20.

As a specific example, the providing unit 15d highlights the detected symbol associated with the control instrument “FC7100” and the detected line associated with the piping “P7017” by coloring the symbol and the line in blue as the flow direction detection information, and, furthermore, transmits, to the plant administrator terminal 20 that is used by the plant administrator O identified by the “plant administrator PO001”, the flow direction detection drawing of the “plant drawing PD001” in which the curve with the blue arrow that indicates the flow direction of the fluid or the signal that flows through the symbol associated with the control instrument “FC7100” and the line associated with the piping “P7017” is displayed by being superimposed on the symbol and the line, the connection relation of the symbol associated with the control instrument “FC7100” and the line associated with the piping “P7017”, and the flow direction detection list {“FC7100-6” →“P7017-2” →“FC7100-6”, and . . . } that indicates the flow direction of the fluid or the signal.

### 2-2-2-5. Notification Unit 15e

The notification unit 15e performs the output result acquisition process, the detection mistake notification process, and the like.

### Output Result Acquisition Process

The notification unit 15e acquires an output result by using the trained machine learning model that outputs the flow direction included in the plant drawing in accordance with an input of each of the digital data on the plant drawing, the symbol pattern, and the line pattern.

As a specific example, the notification unit 15e inputs plant drawing information on the “plant drawing PD001”, the symbol pattern {diagram: “circle/line segment/square”, line type: “solid line”}, and the line pattern {thickness: “1.0 pt”, line type: “solid line”} to the detection model DM included in the detection model storage unit 14d, and acquires {“FC7100-6” →“P7017-2” →“FC7100-6” →“P7017-3” →“FC7100-4”, and . . . } that is the output result of the detection model DM.

### Detection Mistake Notification Process

The notification unit 15e notifies the plant administrator O of a detection omission or erroneous detection of the flow direction obtained by using the output result of the trained machine learning model.

As a specific example, the notification unit 15e compares the flow direction detection list {“FC7100-6”→“P7017-2” →“FC7100-6”, and . . . } that has been detected by the detection unit 15c with {“FC7100-6” →“P7017-2”→“FC7100-6” →“P7017-3” →“FC7100-4”, and . . . } that is the output result of the detection model DM, determines a possibility of a detection omission of the flow direction between the line associated with the piping “P7017” that is the identification information “P7017-3” and the symbol associated with the piping “FC7100” that is the identification information “FC7100-4”, generates a message indicating that “There is a possibility of a detection omission.”, or the like as the detection mistake information, and transmits the generated detection mistake information to the plant administrator terminal 20 that is used by the plant administrator O identified by the “plant administrator PO001”.

### 2-3. Configuration Example and Process Example of Plant Administrator Terminal 20

A configuration example and a process example of the plant administrator terminal 20 will be described with reference to FIG. 20. The plant administrator terminal 20 is a terminal that is used by the plant administrator O who manages the plant, and includes the input/output unit 21, the control unit 22, and the communication unit 23.

### 2-3-1. Input/Output Unit 21

The input/output unit 21 manages an input of various kinds of information with respect to the plant administrator terminal 20. For example, the input/output unit 21 is implemented by a mouse, a keyboard, a touch panel, or the like, and receives an input of the setting information and the like with respect to the plant administrator terminal 20. Furthermore, the input/output unit 21 displays various kinds of information received from the plant administrator terminal 20. For example, the input/output unit 21 is implemented by a display or the like, and displays the setting information and the like that are stored in the plant administrator terminal 20.

The input/output unit 21 displays the plant drawing that is browsed by the plant administrator O. Furthermore, the plant drawing in detail will be described later in the section titled (2-3-4. Specific example 1 of display screen displayed on the plant administrator terminal 20). Furthermore, the input/output unit 21 displays a symbol and line selection screen by which the plant administrator O is able to select a symbol and a line. Furthermore, the symbol and line selection screen in detail will be described later in the section titled (2-3-5. Specific example 2 of display screen displayed on the plant administrator terminal 20). Furthermore, the input/output unit 21 displays the symbol and line detection drawing that is browsed by the plant administrator O. Furthermore, the symbol and line detection drawing in detail will be described later in the section titled (2-3-6. Specific example 3 of display screen displayed on the plant administrator terminal 20).

### 2-3-2. Control Unit 22

The control unit 22 receives various kinds of information. For example, the control unit 22 transmits the plant drawing information on the plant drawing that has been selected by the plant administrator O to the server device 10-2. Furthermore, the control unit 22 transmits the symbol selection information on the symbol that has been selected by the plant administrator O on the symbol selection screen to the server device 10-3. Furthermore, the control unit 22 transmits the line selection information on the line that has been selected by the plant administrator O on the line selection screen to the server device 10-3.

The control unit 22 receives various kinds of information. For example, the control unit 22 receives the symbol detection information that includes the symbol detection drawing, the symbol detection list, and the like that are displayed by the input/output unit 21 from the server device 10-3. Furthermore, the control unit 22 receives the line detection information including the line detection drawing, the line detection list, and the like that are displayed on the input/output unit 21 from the server device 10-3. Furthermore, the control unit 22 receives the flow direction detection information including the flow direction detection drawing, the flow direction detection list, and the like that are displayed by the input/output unit 21 from the server device 10-3. Furthermore, the control unit 22 receives, from the server device 10-3, the detection mistake information that is displayed on the input/output unit 21, that indicates a detection omission of a symbol, a line, a flow direction, or the like or erroneous detection, and that is notified to the plant administrator O.

### 2-3-3. Communication Unit 23

The communication unit 23 manages data communication performed with the other devices. For example, the communication unit 23 performs data communication with each of the communication devices via a router or the like. Furthermore, the communication unit 23 is able to perform data communication with a terminal that is used by an operator (not illustrated).

### 2-3-4. Specific Example 1 of Display Screen Displayed on Plant Administrator Terminal 20

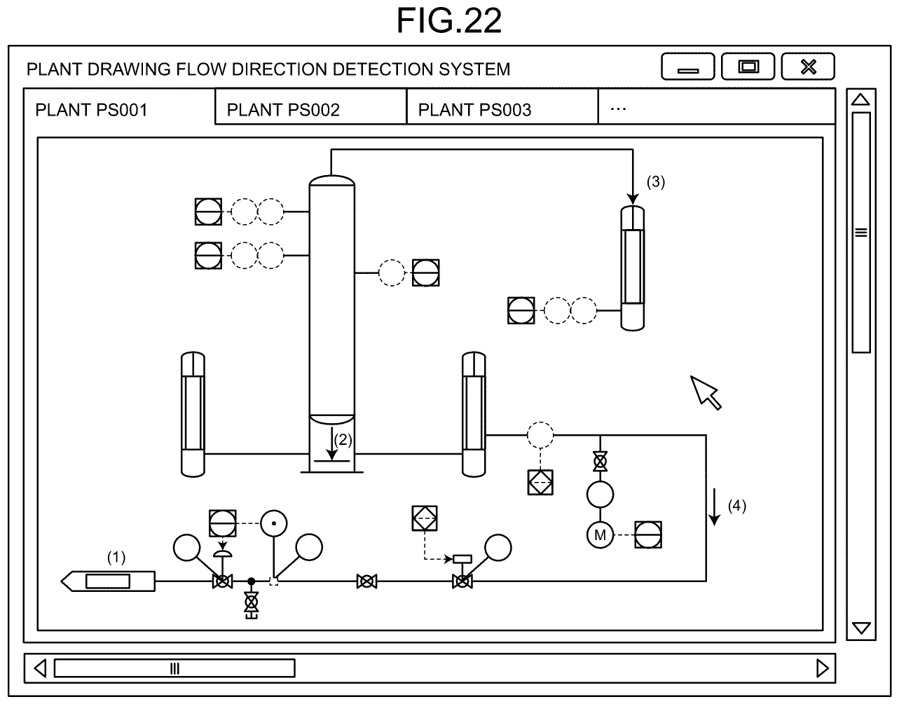

Here, a specific example 1 of a display screen that is output by the input/output unit 21 included in the plant administrator terminal 20 will be described with reference to FIG. 22. FIG. 22 is a diagram illustrating the specific example 1 of the display screen displayed on the plant administrator terminal 20 according to the third embodiment. In the following, a plant drawing that is browsed by the plant administrator O will be described.

### 2-3-4-1. Plant Drawing

As indicated by the example illustrated in FIG. 22, the plant administrator terminal 20 displays, for each plant, the plant drawing that has been generated by the symbols that indicate the respective components included in the plant and the lines that indicate the respective connection elements and that connect the respective components included in the plant. In the example illustrated in FIG. 22, in the plant drawing indicated by the “plant PS001”, the symbol associated with the control device and the line associated with the piping that the plant administrator O desires to detect are displayed. Furthermore, as a flow direction specifying sign that is the sign for specifying the flow direction that the plant administrator O desires to detect, the arrows (see (2) to (4) in FIG. 22), and the arrow feather diagram (see (1) in FIG. 22) are displayed.

### 2-3-4-2. Flow Direction Specifying Sign

In the example illustrated in FIG. 22, the arrow feather diagram indicated by (1) illustrated in FIG. 22 indicates that a fluid or the like flows from the right to the left of the drawing, the arrow indicated by (2) illustrated in FIG. 22 indicates that the fluid or the like flows from the upper part to the lower part of the drawing, the arrow indicated by (3) illustrated in FIG. 22 indicates that the fluid or the like flows from the upper part to the lower part of the drawing, and the arrow indicated by (4) illustrated in FIG. 22 indicates that the fluid or the like flows from the upper part to the lower part of the drawing.

### 2-3-5. Specific Example 2 of Display Screen Displayed on Plant Administrator Terminal 20

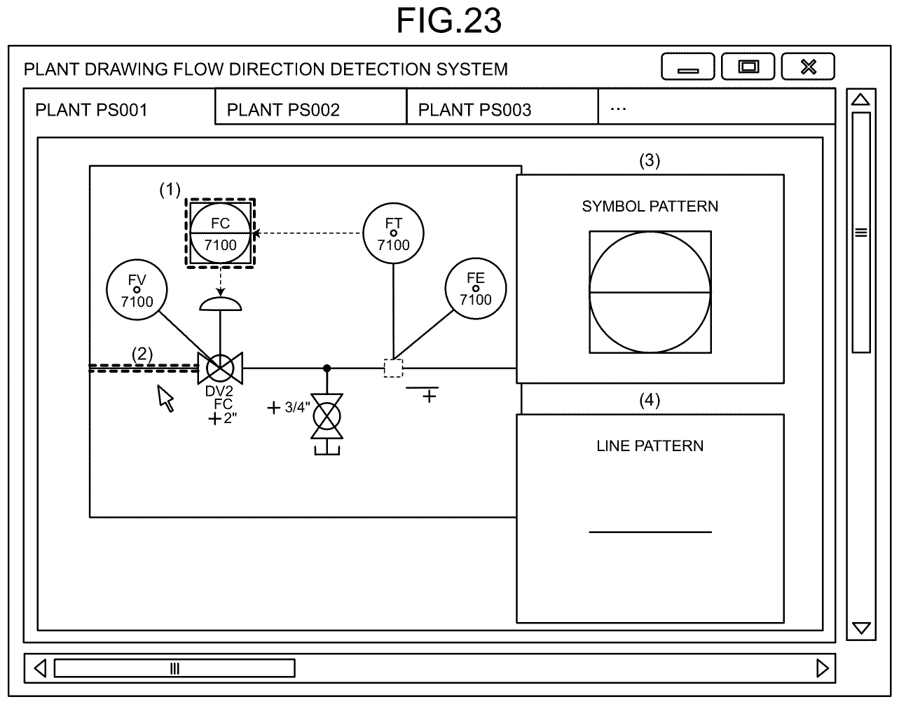

Here, a specific example 2 of the display screen that is output by the input/output unit 21 included in the plant administrator terminal 20 will be described with reference to FIG. 23. FIG. 23 is a diagram illustrating the specific example 2 of the display screen displayed on the plant administrator terminal 20 according to the third embodiment. In the following, a symbol and line selection screen by which the plant administrator O is able to select a symbol and a line will be described.

### 2-3-5-1. Symbol and Line Selection Screen

As indicated by the example illustrated in FIG. 23, the plant administrator terminal 20 displays the symbol and line selection screen that enables the plant administrator O to select, on the plant drawing, the symbol and the line that the plant administrator O desires to select. In the example illustrated in FIG. 23, in the plant drawing indicated by the “plant PS001”, the plant administrator terminal 20 displays the plant drawing in which an area around the symbol (see (1) in FIG. 23) associated with the control instrument that the plant administrator O desires to detect has been enlarged. At this time, the plant administrator O is able to select the symbol by performing a click operation on the symbol that the plant administrator O desires to detect. Furthermore, in the plant drawing indicated by the “plant PS001”, the plant administrator terminal 20 displays the plant drawing in which an area around the line (see (2) in FIG. 23) associated with the piping that the plant administrator O desires to detect has been enlarged. At this time, the plant administrator O is able to select the line by performing a click operation on the line that the plant administrator O desires to detect.

Furthermore, the plant administrator terminal 20 displays the symbol pattern (see (3) in FIG. 23) of the symbol that has been enlarged and that has been selected by the plant administrator O on the plant drawing. At this time, the plant administrator O is also able to correct the diagram of the displayed symbol pattern, or also able to delete the text attached to the symbol. Furthermore, the plant administrator terminal 20 displays the line pattern (see (4) in FIG. 23) associated with the line that has been enlarged and that has been selected by the plant administrator O on the plant drawing. At this time, the plant administrator O is also able to correct the diagram of the displayed line pattern, or also able to delete the line number attached to the line.

### 2-3-5-2. Assignment of Flow Direction Specifying Sign

The plant administrator O is able to assign the flow direction specifying sign at the time of detection of the flow direction. For example, the plant administrator O is able to assign the flow direction specifying sign as the flow direction specifying sign that the plant administrator O desires to reflect by performing a click operation on an arbitrary arrow or an arbitrary arrow feather diagram.

### 2-3-6. Specific Example 3 of Display Screen Displayed on Plant Administrator Terminal 20

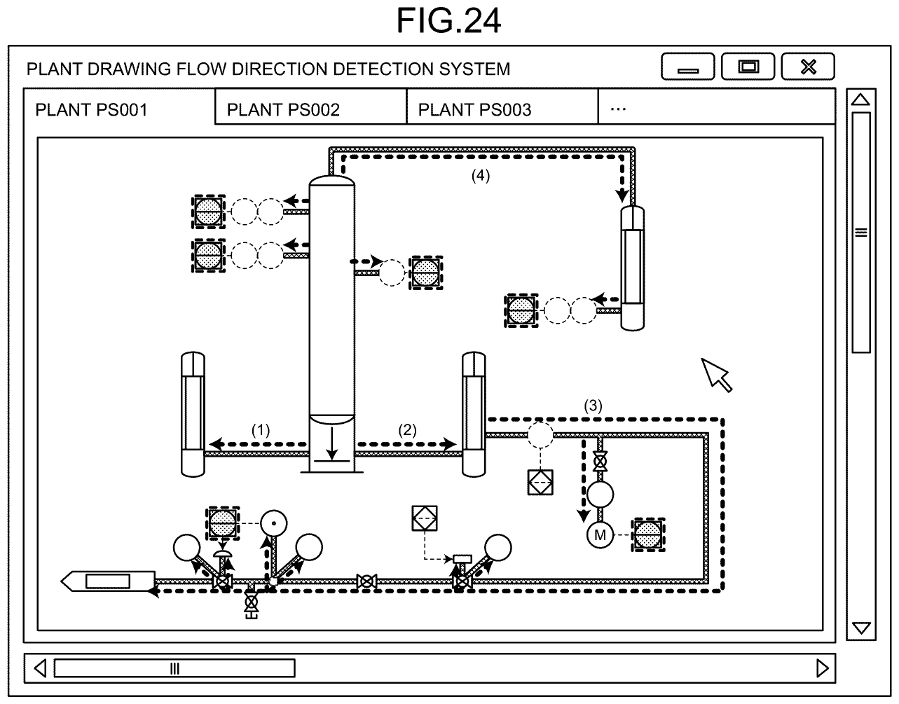

Here, a specific example 3 of the display screen that is output by the input/output unit 21 included in the plant administrator terminal 20 will be described with reference to FIG. 24. FIG. 24 is a diagram illustrating the specific example 3 of the display screen displayed on the plant administrator terminal 20 according to the third embodiment. In the following, the flow direction detection drawing browsed by the plant administrator O will be described.

### 2-3-6-1. Flow Direction Detection Drawing

As indicated by the example illustrated in FIG. 24, the plant administrator terminal 20 displays the flow direction detection drawing in which the symbol associated with the detected control instrument and the line associated with the detected piping are highlighted by coloring in blue, and furthermore, the curves with blue arrow (see (1) to (4) in FIG. 24) each of which indicates the flow direction of the fluid or the signal that flows through the symbol associated with the control instrument and the line associated with the piping are superimposed on the symbol and the line.

### 2-3-6-2. Flow Direction Detection List

The plant administrator terminal 20 is also able to display the flow direction detection list that is the list of the detected flow direction. For example, the plant administrator terminal 20 is also able to display, as the flow direction detection list, the identification information and the positional information on the detected control device, the identification information and the positional information on the detected piping, and the flow direction detection list that indicates the flow direction between the control device and the piping.

### 2-3-6-3. Notification of Detection Mistake

The plant administrator terminal 20 is also able to display a detection mistake notification that indicates a possibility of a detection omission or erroneous detection of the flow direction. For example, the plant administrator terminal 20 is also able to display a message indicating that “There is a possibility of a detection omission.”, or the like as the detection mistake notification.

### 3. Flow of Process Performed in Information Providing System 100-3

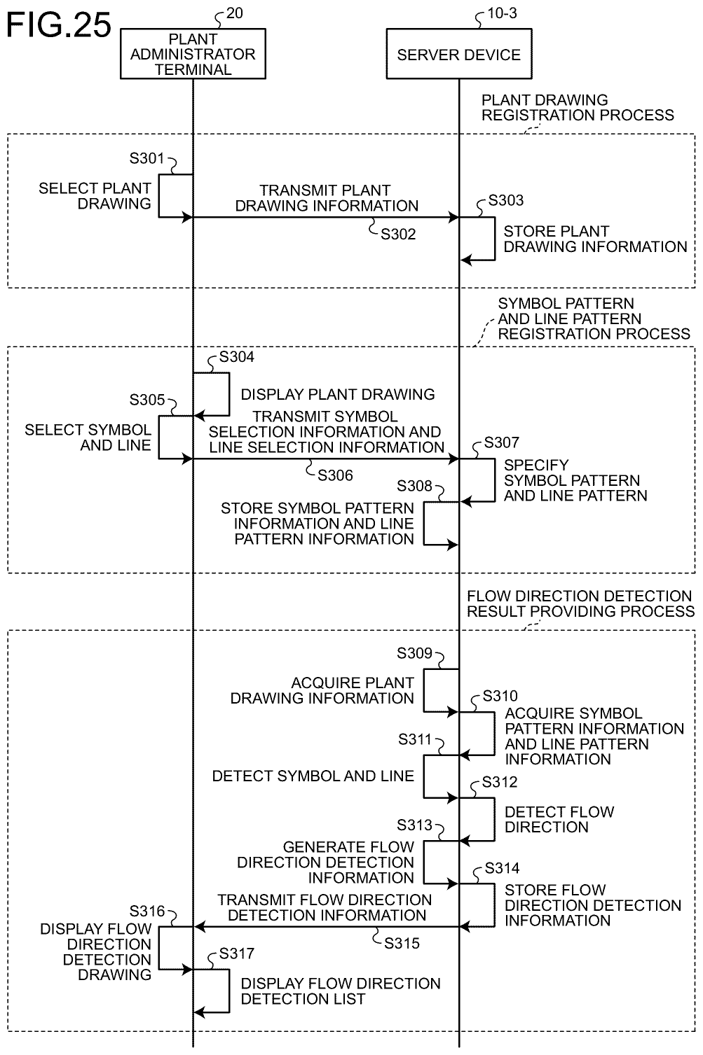

The flow of the process performed in the information providing system 100-3 according to the second embodiment will be described with reference to FIG. 25. FIG. 25 is a sequence diagram illustrating one example of the flow of the process performed in the information providing system 100-3 according to the third embodiment. In the following, explanations will be given in the order of the plant drawing registration process, the symbol pattern and line pattern registration process, and the flow direction detection result providing process. Furthermore, the processes at Steps S301 to S317 may also be performed in different order. Moreover, from among the processes at Steps S301 to S317 described below, there may be a process that is omitted.

### 3-1. Plant Drawing Registration Process

The information providing system 100-3 performs the plant drawing registration process that is indicated by the processes at Steps S301 to S303 described blow.

At a first step, the plant administrator terminal 20 performs the plant drawing selection process (Step S301). For example, the plant administrator terminal 20 accepts the plant drawing of the plant that has been selected by the operation performed by the plant administrator O. At a second step, the plant administrator terminal 20 performs the plant drawing information transmission process (Step S302). For example, the plant administrator terminal 20 transmits, to the server device 10-3, the digital data on the plant drawing of the plant that has been selected by the operation performed by the plant administrator O. At a third step, the server device 10-3 performs the plant drawing information storing process (Step S303). For example, the server device 10-3 stores the plant drawing information received from the plant administrator terminal 20 for each of the plant administrators O.

### 3-2. Symbol Pattern and Line Pattern Registration Process

The information providing system 100-3 performs the symbol pattern and line pattern registration process that is indicated by the processes at Steps S304 to S308 described below.

At a first step, the plant administrator terminal 20 performs the plant drawing displaying process (Step S304). For example, the plant administrator terminal 20 displays, on the monitor screen, the plant drawing of the plant that has been selected by an operation performed by the plant administrator O. At a second step, the plant administrator terminal 20 performs the symbol and the line selection process (Step S305). For example, the plant administrator terminal 20 accepts the symbol that has been selected by the operation performed by the plant administrator O on the plant drawing, and accepts the line that has been selected by the operation performed by the plant administrator O on the plant drawing. At a third step, the plant administrator terminal 20 performs the symbol selection information and line selection information transmission process (Step S306). For example, the plant administrator terminal 20 transmits, to the server device 10-3, the identification information on the symbol that has been selected by the operation performed by the plant administrator O and the positional information on the position of the symbol indicated in the plant drawing, and transmits, to the server device 10-3, the identification information on the line that has been selected by the operation performed by the plant administrator O and the positional information on the position of the line indicated on the plant drawing. At a fourth step, the server device 10-3 performs the symbol pattern and line pattern specifying process (Step S307). For example, the server device 10-3 refers to the plant drawing information on the basis of the symbol selection information received from the plant administrator terminal 20, specifies the symbol pattern from the digital data on the plant drawing information, refers to the plant drawing information on the basis of the line selection information received from the plant administrator terminal 20, and specifies the line pattern from the digital data on the plant drawing information. At a fifth step, the server device 10-3 performs the symbol pattern information and line pattern information storing process (Step S308). For example, the server device 10-3 stores, for each of the plant administrator O, the symbol pattern information that includes the specified symbol pattern, and stores, for each of the plant administrator O, the line pattern information that includes the specified line pattern.

### 3-3. Flow Direction Detection Result Providing Process

The information providing system 100-3 performs the flow direction detection result providing process that is indicated by the processes at Steps S309 to S317 described below.

At a first step, the server device 10-3 performs the plant drawing information acquisition process (Step S309). For example, the server device 10-3 accepts a request for detecting the flow direction made by an operation performed by the plant administrator O, searches the stored plant drawing information, and acquires the plant drawing information on the corresponding plant. At a second step, the server device 10-3 performs the symbol pattern information and line pattern information acquisition process (Step S310). For example, the server device 10-3 accepts a request for detecting the symbol and the line made by an operation performed by the plant administrator O, searches the stored symbol pattern information and the stored line pattern information, and acquires the symbol pattern information on the corresponding symbol and the line pattern information on the corresponding line. At a third step, the server device 10-3 performs the symbol and line detection process (Step S311). For example, the server device 10-3 searches the acquired plant drawing information, detects the symbol having the symbol pattern that is matched with the symbol pattern indicated by the acquired symbol pattern information, and detects the line having the line pattern that is matched with the acquired line pattern information. At a fourth step, the server device 10-3 performs the flow direction detection process (Step S312). For example, the server device 10-3 detects the flow direction by using the detected symbol, the detected line, and the flow direction specifying sign that is included in the acquired plant drawing information. At a fifth step, the server device 10-3 performs the flow direction detection information generating process (Step S313). For example, the server device 10-3 generates the line detection drawing in which the curve with the arrow that indicates the detected flow direction is displayed in a superimposed manner, and the flow direction detection list that indicates the list of the detected flow directions. At a sixth step, the server device 10-3 performs the flow direction detection information storing process (Step S314). For example, the server device 10-3 stores, for each of the plant administrator O, the flow direction detection information that includes the generated flow direction detection drawing and the flow direction detection list. At a seventh step, the server device 10-3 performs the flow direction detection information transmission process (Step S315). For example, the server device 10-3 transmits, to the plant administrator terminal 20, the flow direction detection information that includes the generated flow direction detection drawing and the flow direction detection list. At an eighth step, the plant administrator terminal 20 performs the flow direction detection drawing displaying process (Step S316). For example, the plant administrator terminal 20 displays the flow direction detection drawing that is included in the flow direction detection information received from the server device 10-3 on the monitor screen. At a ninth step, the plant administrator terminal 20 performs the flow direction detection list displaying process (Step S317). For example, the plant administrator terminal 20 displays the flow direction detection list that is included in the flow direction detection information received from the server device 10-3 on the monitor screen.

### 4. Effects of Third Embodiment

Lastly, the effects of the third embodiment will be described. In the following, effects 1 and 2 associated with the processes according to the third embodiment will be described.

### 4-1. Effect 1

At a first step, in the above described processes according to the third embodiment, the server device 10-3 receives the plant drawing that has been generated by using each of the symbols that indicate the plurality of respective components constituting the plant, accepts, from the plant administrator terminal 20, selection of an arbitrary component from among the plurality of components, detects a symbol from among the symbols that are included in the plant drawing on the basis of the symbol pattern of the symbol that indicates the selected component, and transmits the symbol detection information related to the detected symbol to the plant administrator terminal 20. Furthermore, the server device 10-3 receives the plant drawing that has been generated by using each of the lines that indicate the plurality of respective connection elements that connect the components constituting the plant, accepts selection of an arbitrary connection element included in the plurality of connection elements made by the plant administrator terminal 20, detects a line from among the lines that are included in the plant drawing on the basis of the line pattern of the line that indicates the selected connection element, and transmits the line detection information related to the detected line to the plant administrator terminal 20. As a result of this, in the processes according to the third embodiment, it is possible to efficiently provide the information related to the symbols and the lines that are included in the plant drawing.

### 4-2. Effect 2

At a second step, in the processes according to the third embodiment, the server device 10-3 detects the flow direction of a fluid or a signal included in the plant drawing, and transmits the information related to the detected flow direction to the plant administrator terminal 20. As a result of this, in the processes according to the third embodiment, it is possible to efficiently provide the information related to the symbols, lines, and the flow directions included in the plant drawing.

### System

The flow of the processes, the control procedures, the specific names, and the information containing various kinds of data or parameters indicated in the above specification and drawings can be arbitrarily changed unless otherwise stated.

Furthermore, the components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, all or any part of each of the processing functions performed by the each of the devices can be implemented by a CPU and by programs analyzed and executed by the CPU or implemented as hardware by wired logic.

### Hardware

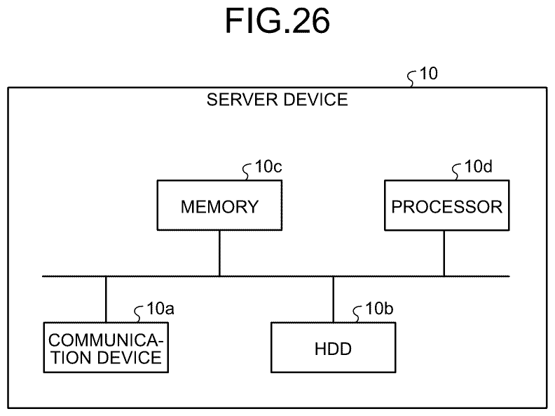

In the following, an example of a hardware configuration of a server device 10 (10-1, 10-2, and 10-3) will be described. FIG. 26 is a diagram illustrating an example of the hardware configuration according to the first embodiment to the third embodiment. As illustrated in FIG. 26, the server device 10 includes a communication device 10a, a hard disk drive (HDD) 10b, a memory 10c, and a processor 10d. Furthermore, each of the units illustrated in FIG. 26 is connected by a bus or the like with each other.

The communication device 10a is a network interface card or the like, and communicates with another server. The HDD 10b stores therein the programs and the DBs that operate the functions illustrated in FIG. 2, FIG. 12, and FIG. 20.

The processor 10d operates the process that executes each of the functions described above in FIG. 2, FIG. 12, and FIG. 20 by reading the programs that execute the same process as that performed by each of the processing units illustrated in FIG. 2, FIG. 12, and FIG. 20 from the HDD 10b or the like and loading the read programs in the memory 10c. For example, the process executes the same functions as those performed by each of the processing units included in the server device 10. Specifically, the processor 10d reads, from the HDD 10b or the like, the programs having the same functions as those performed by the acquisition unit 15a, the acceptance unit 15b, the detection unit 15c, the providing unit 15d, the notification unit 15e, and the like. The processor 10d executes the process for executing the same processes as those performed by the acquisition unit 15a, the acceptance unit 15b, the detection unit 15c, the providing unit 15d, the notification unit 15e, and the like.

In this way, the server device 10 is operated as a device that performs various processing methods by reading and executing the programs. Furthermore, the server device 10 is also able to implement the same functions as those described above in the embodiment by reading the above described programs from a recording medium by a medium reading device and executing the read programs. Furthermore, the programs described in another embodiment are not limited to be executed by the server device 10. For example, the present invention may also be similarly used in a case in which another computer or a server executes a program or in a case in which another computer and a server cooperatively execute the program with each other.

The programs may be distributed via a network, such as the Internet. Furthermore, the programs may be executed by storing the programs in a recording medium that can be read by a computer readable medium, such as a hard disk, a flexible disk (FD), a CD-ROM, a magneto-optical disk (MO), a digital versatile disk (DVD), or the like, and read the programs from the recording medium by the computer.

According to the present invention, an advantage is provided in that it is possible to efficiently provide information related to a line from a drawing related to a plant.

What is claimed is:

1. A plant drawing line detection system comprising:
a control unit that is configured to
acquire a drawing that is used for construction, operation, and maintenance of a plant;
display the acquired drawing;
accept selection of a line that is desired from among a plurality of lines that are present in the displayed drawing;
register a pattern of the accepted selection of the line;
detect, from the displayed drawing, all of the lines each having a shape that is matched with a shape of the registered pattern of the line including the line that has been used for the selection; and
provide a detection result related to the lines.

2. The plant drawing line detection system according to claim 1, wherein the control unit
acquires, as the drawing, drawing data that includes the plurality of lines that are generated from digital data,
accepts the line that has been selected by an operation performed by a user on the drawing that is displayed on a user terminal,
specifies at least one of a thickness, a line type, and a color of the line as the pattern of the accepted selection of the line accepted by using the digital data, and
detects all of the lines having the matched pattern from among the plurality of lines that are included in the drawing.

3. The plant drawing line detection system according to claim 2, wherein the control unit
further specifies an orientation of the accepted selection of the line, and
detects all of the lines having the matched orientation from among the plurality of lines that are included in the drawing.

4. The plant drawing line detection system according to claim 2, wherein the control unit
further specifies a line number attached to the accepted selection of the line, and
detects all of the lines with the matched line number from among the plurality of lines that are included in the drawing.

5. The plant drawing line detection system according to claim 1, wherein the control unit generates, as the detection result related to the lines, at least one of the drawing, in which the detected lines are highlighted, and a list of the detected lines.

6. The plant drawing line detection system according to claim 1, wherein the control unit
accepts selection of a symbol that is desired from among a plurality of symbols that are present in the displayed drawing,
registers a pattern of the accepted selection of the symbol,
detects, from the displayed drawing, all of the symbols each having a shape that is matched with a shape of the registered pattern of the symbol including the symbol that has been used for the selection, and
provides a detection result related to the symbols.

7. The plant drawing line detection system according to claim 6, wherein the control unit
detects a flow direction of a fluid or a signal in the drawing, and
provides a detection result related to the detected flow direction to a user.

8. The plant drawing line detection system according to claim 1, wherein the control unit notifies the user of a detection omission or erroneous detection of the lines by using a trained machine learning model that outputs each of the lines included in the drawing in accordance with an input of the digital data on the drawing and the pattern of each of the lines.

9. A plant drawing line detection method that causes a computer to execute a process comprising:
acquiring a drawing that is used for construction, operation, and maintenance of a plant;
displaying the acquired drawing;
accepting selection of a line that is desired from among a plurality of lines that are present in the displayed drawing;
registering a pattern of the accepted selection of the line;
detecting, from the displayed drawing, all of the lines each having a shape that is matched with a shape of the registered pattern of the line including the line that has been used for the selection; and
providing a detection result related to the lines.

10. A computer-readable recording medium having stored therein a plant drawing line detection program that causes a computer to execute a process comprising:
acquiring a drawing that is used for construction, operation, and maintenance of a plant;
displaying the acquired drawing;
accepting selection of a line that is desired from among a plurality of lines that are present in the displayed drawing;
registering a pattern of the accepted selection of the line;
detecting, from the displayed drawing, all of the lines each having a shape that is matched with a shape of the registered pattern of the line including the line that has been used for the selection; and
providing a detection result related to the lines.
